(19) United States
(12) Patent Application Publication
(10) Pub. No.: US 2023/0022648 A1
(43) Pub. Date: Jan. 26, 2023

(54) BIOSENSOR HAVING A FLUID COMPARTMENT

(71) Applicants: Tower Semiconductor Ltd., Migdal Haemek (IL); B.G. Negev Technologies and Applications Ltd., at Ben-Gurion University, Beer-Sheva (IL)

(72) Inventors: Gil Shalev, Ramat Hasharon (IL); Yakov Roizin, Afula (IL); Pikhay Evgeny, Haifa (IL); Ie Mei Bhattacharyya, Beersheva (IL); Izhar Ron, Gedera (IL); Doron Greental, Kiryat Tivon (IL)

(73) Assignees: Tower Semiconductor Ltd., Migdal Haemek (IL); B.G. Negev Technologies and Applications Ltd., at Ben-Gurion University, Beer-Sheva (IL)

(21) Appl. No.: 17/305,805

(22) Filed: Jul. 14, 2021

(51) Int. Cl. G01N 27/414

(52) U.S. Cl. CPC G01N 27/4145

(57) ABSTRACT

A biosensor that includes a semiconductor active region; a sensing region configured to contact a fluid; and multiple electrodes that comprise decoupling electrodes and additional electrodes. The decoupling electrodes may be configured, wherein operating in a first mode, to prevent a formation of a top conductive channel within the semiconductor active region; and wherein the additional electrodes are configured, wherein operating in the first mode, to independently control (i) one or more properties of one or more other conductive channels formed within the semiconductor active region, and (ii) a Debye length at an interface between the sensing region and the fluid.

### BACKGROUND OF THE INVENTION

Label-free bio-assays are sensing platforms that directly measure biomolecular and cellular interactions, provide extensive perspectives on the affinity and specificity as well as the thermodynamics and kinetics of various biological systems.

Few examples of a biologically-modified field-effect transistor (BioFET) are illustrated in (a) Cheung, K. M.; Abendroth, J. M.; Nakatsuka, N.; Zhu, B.; Yang, Y.; Andrews, A. M.; Weiss, P. S. Detecting DNA and RNA and Differentiating Single-Nucleotide Variations via Field-Effect Transistors. Nano Lett. 2020, 20 (8), 5982-5990, (b) Nakatsuka, N.; Yang, K. A.; Abendroth, J. M.; Cheung, K. M.; Xu, X.; Yang, H.; Zhao, C.; Zhu, B.; Rim, Y. S.; Yang, Y.; et al. Aptamer-Field-Effect Transistors Overcome Debye Length Limitations for Small-Molecule Sensing. Science (80-.). 2018, 362 (6412), 319-324, (c) Kaisti, M. Detection Principles of Biological and Chemical FET Sensors. Biosens. Bioelectron. 2017, 98 (April), 437-448, and (d) Patolsky, F.; Zheng, G.; Lieber, C. M. Nanowire-Based Biosensors. Anal. Chem. 2006, 78 (13), 4260-4269.

The main recognizable obstacle in the application of BioFETs is the electronic screening length which is critical in highly-concentrated ionic solutions.

The screening length is reflected by the Debye length (λ_{D}), which at room temperature is defined as

$${λ}_{D} = \frac{1}{\sqrt{4 π {l}_{B} {N}_{A v} {\sum }_{i} {n}_{B , i} {z}_{i}^{2}}} ,$$

where 1_{B}=0.7 nm is the Bjerrum length, N_{AV} is the Avogadro's number, zᵢ and n_{B,i} are the valence and solution concentration of ion type i, correspondently, where the summation accounts for the various types of ions.

In a characteristic physiological solution, λ_{D}=1-2 nm, which is significantly smaller than typical surface-bound antibody (˜10 nm), for example, which seriously affects the possibility to sense target biomoleucles. Therefore, in case of serum, for example, the sample ion concentration needs to be significantly decreased, that might influence the biological events, or shorter bioreceptors have to be employed.

The protonation of the amphoteric sites by the solution yields a surface charge density (σ₀) which depends on the solution acidity. The interactions at the electrolyte-Oxide interface (EOI) are determined by the site-binding model. To force local charge neutrality, an equivalent counter-charged solvent ions are adsorbed on the EOI, resulting in the appearance of the double layer.

De facto, the problem of screening length is most severe at the double layer. The concentrations of ions at a distance x from the EOI are defined by the Boltzmann distributions:

$${n}_{+} = {n}_{+ , B} exp ( - \frac{{z}_{+} q ψ ( x )}{k T} ) and \\ {n}_{-} = {n}_{- , B} exp ( \frac{{z}_{-} q ψ ( x )}{k T} ) ,$$

where n_{+,B} and n_{-,B} are the positive and negative bulk ion concentrations, ψ(x) is the electric potential, and q, k and T take their conventional meaning. Correspondingly, the 1D Poisson-Boltzmann equation is

$$\frac{{d}^{2} ψ ( x )}{d {x}^{2}} = - \frac{q}{ε} {\sum }_{i} {n}_{B , i} {z}_{i} exp ( \frac{- {z}_{i} q ψ ( x )}{k T} ) ,$$

where ε is the relative electrolyte permittivity.

For EOI surface potential ψ₀<kT/q, the double layer adheres to the Debye-Huckel model and the co- and counter-ions concentrations are linear with the electric potential and, therefore, a surplus of counter-ions forces an equivalent lack of co-ions. On the other hand, according to the Gouy-Chapman model, ψ₀>kT/q, the population of counter-ions is substaintially greater. The Gouy-Chapman approximation is more relevant in the context of bioFETs, as it conforms to ψ₀ values of applicable dielectrics for a considerable pH range and ionic strengths; hence, the double layer total ion concentration (n₀) is considerably greater than n_{B} under the Gouy-Chapman approximation. Also, the integration of the one-dimensional Poisson-Boltzmann equation for relevant symmetric and asymmetric electrolyte produces the Grahame equation which sets the affinity between n₀ and σ₀ as Σᵢn₀ᵢ=Σᵢn_{Bi}+2πσ₀²/εkT, where i counts the ion species; the Grahame expression suggests that n₀ is always higher than n_{B} and the surplus concentration depends solely on σ₀.

The Poisson-Boltzmann equation accounts for the electrostatic behavior while other phenomena, i.e. e.g. steric effects and dielectric decrement, affect the double layer kinetics as well. However, all these phenomena also show n₀>>n_{B}. Therefore, the electrostatic potential distribution and the double layer total ion concentration are independent of n_{B} close to the interface and the surplus ions near the interface entail an appreciable reduced λ_{D}. Therefore, the maximum screening takes place at the EOI and diminishes with the Debye distance.

Furthermore—The CMOS BioFET research has focused primarily on the modification of a standard silicon metal-oxide-semiconductor FET (MOSFET) into a BioFET by removal of the top metal gate and biofunctionalization of the gate dielectric (or very small modifications in that spirit as, for example, the extended gate BioFET), which yielded only very few recognizable achievements.

This should not come as a great surprise, as the functionality of a MOSFET is fundamentally different than the required functionality of a BioFET. The uniform band-bending at the MOSFET silicon/gate-dielectric interface, due to the biasing of the top metal gate, triggers a homogeneous modulation of the conductive channel.

On the other hand, the silicon/gate-dielectric band bending in a BioFET is fundamentally non-uniform, as it depends on local biological interactions that are distributed on top of the active sensing area (i.e., gate dielectric). Hence, the biological-solid interface of the BioFET is far more complex and non-uniform compared with the all-solid-state interface of the MOSFET; e.g., the inevitable non-uniform distribution of receptor molecules on the top of the active sensing area implies a non-uniform distribution of binding events, which results in a spatially distributed silicon/gate-dielectric band bending. Therefore, in order to directly probe the electrostatic signature of biological events, the BioFET design needs to address the challenge of the non-uniform biological-solid interface.

There is a growing need to provide a device and a method for biological sensing that overcomes said disadvantages of the prior art devices.

### SUMMARY

Specific and label-free sensing of biological events is important in various technological applications ranging from medical devices to home security, as well as for the understanding of fundamental questions related to the electronic nature of biological interactions. The biologically modified field-effect transistor (BioFET) is a promising device for specific and label-free biosensing due to its sub-micron footprint, inherent signal amplification and the ability to perform multiplexing in an ultra-small sample volume.

Debye screening length poses a significant obstacle towards the realization of a BioFET. Debye length prevents recognition of biological events that take place at a distance from the active sensing area that is greater than the Debye length. In fact, the obstacle of screening distance is more acute at the solid-solution interface (double layer) as, inherently, the solution ion population at the interface is significantly higher than the bulk solution. Therefore, the screening length at the interface is substantially smaller than its bulk value. One way to address the small screening length at the interface is to bias the solution relative to the sample and realize bulk screening length at the interface. However, biasing of the solution directly affects the conductive channel, as well.

The current application addresses the Debye length challenge with the novel Meta-Nano-Channel (MNC) BioFET. The MNC BioFET, which is fabricated in a complementary-metal-oxide-silicon (CMOS) process, allows to decouple the electrostatics of the double layer from the electrodynamics of the conductive channel.

The application explores the mechanism of sensing with the MNC BioFET and demonstrates how the double layer can be biased in order to optimize the screening length, but at the same time maintain a conductive channel that is extremely sensitive to potential variations triggered by biological interactions.

Specific and label-free detection of biological interactions is paramount to a plethora of technological applications ranging from home-care diagnostics to new approaches for smart agriculture, as well as the ability to inquire into fundamental phenomena related to biological events. The biologically-modified field-effect transistor (BioFET) fabricated in a complementary metal-oxide-semiconductor (CMOS) process is a favourable system for the realization of specific and label-free bio-detection due to the stability of sensor characteristics, operation flexibility including the potential for multiplexing, low power and low cost. The Meta-Nano-Channel BioFET (MNC BioFET) is a novel multi-gate biosensor realized with silicon-on-insulator (SOI) technology and fabricated in a CMOS process. The MNC BioFET allows to form conductive channels of various shapes and sizes. This is used to optimize the coupling between the electrostatic events induced by the biological interactions and the electrostatics of the underlying silicon-based transistor. As an example , in the current application, we demonstrate specific and label-free sensing of prostate specific antigen (PSA) with the MNC BioFET, and show the dependency of the sensor signal on the channel configuration.

In the current application, a novel Meta-Nano-Channel (MNC) BioFET is suggested to address the ‘non-uniformity’ challenge of BioFET. The MNC BioFET is a multiple-gate device that includes six independent gates. Each gate ‘maps’ the active sensing area differently. As all the gates are electrostatically coupled. An infinite amount of current-voltage (I-V) curves can be generated, each providing different information on the active sensing area, where the biological interactions take place.

### BRIEF DESCRIPTION OF THE DRAWINGS

The patent or application file contains at least one drawing executed in color. Copies of this patent or patent application publication with color drawings will be provided by the Office upon request and payment of the necessary fee.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an example of a biosensor;

FIG. 1B is an example of a graph;

FIG. 1C is an example of a graph;

FIG. 2A is an example of a biosensor;

FIGS. 2B-2O are examples of cross sectional views of one or more biosensors;

FIG. 2P is an example of a biosensor;

FIGS. 3A and 3B are images of a biosensor;

FIGS. 3C-3D are examples of graphs;

FIGS. 4A-4H are examples of graphs;

FIGS. 5A-5H are examples of graphs;

FIGS. 6A-6C are examples of cross sectional views of one or more biosensors;

FIGS. 7A-7C are examples of cross sectional views of one or more biosensors;

FIGS. 8A-8E are examples of top views of one or more biosensors;

FIG. 9 is an example of cross sectional views of one or more biosensors;

FIG. 10A is an example of an array of biosensors;

FIG. 10B is an example of a biosensor and a CMOS transistor;

FIGS. 11A-11C are examples of methods;

FIG. 12A is an example of a method;

FIGS. 12B-12F are examples of graphs; and

FIGS. 13A-13G are examples of graphs.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF THE PREFERRED EMBODIMENTS

In the following detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer readable medium that is non-transitory and stores instructions for executing the method.

Any reference in the specification to a system should be applied mutatis mutandis to a method that may be executed by the system and should be applied mutatis mutandis to a computer readable medium that is non-transitory and stores instructions executable by the system.

Any reference in the specification to a computer readable medium that is non-transitory should be applied mutatis mutandis to a method that may be applied when executing instructions stored in the computer readable medium and should be applied mutatis mutandis to a system configured to execute the instructions stored in the computer readable medium.

And/or referred to additionally or alternatively. “A and/or B” means only A or only B or A and B.

There is provided a biosensor 100 such as a Meta-Nano-Channel (MNC) biosensor to address the ‘Debye challenge’ of the BioFET technology.

According to one example—the MNC biosensor may include six independent gates which may be electrostatically coupled to each other. The multiple gates allow to electrostatically decouple the solution double layer from the conductive channel and in this manner allow the possibility to manipulate the screening length at the solid-solution interface without affecting the transduction performance of the BioFET.

Label-free bio-assays are sensing platforms that directly measure biomolecular and cellular interactions, provide extensive perspectives on the affinity and specificity as well as the thermodynamics and kinetics of various biological systems. The biologically-modified field-effect transistor (BioFET) is an attractive device for specific and label-free sensing, that directly probes the electrostatics and electrodynamics of biological interactions and processes. BioFETs realized in a Complementary Metal Oxide Semiconductor (CMOS) processes have low power, low cost, ultra-low noise levels and high gain. These properties directly lead to enhanced sensing performance in terms of high sensitivity (signal vs. concentration), extremely low limit-of-detection (LOD) and high dynamic range. Furthermore, the built-in miniaturization directly implies small sample size and the potential for multiplexing.

One of the main obstacles in the application of BioFETs is the screening length which is especially significant in highly-concentrated ionic solutions. The screening length is characterized by the Debye length (λ_{D}) which at room temperature is defined as

$${λ}_{D} = \frac{1}{\sqrt{4 π {l}_{B} {N}_{A v} {\sum }_{i} {n}_{B , i} {z}_{i}^{2}}} ,$$

where 1_{B}=0.7 nm is the Bjerrum length, N_{Av} is the Avogadro' s number, zᵢ and n_{B,i} are the valence and solution concentration of ion type i, correspondingly, and the summation accounts for the various types of ions. In a characteristic physiological solution, λ_{D}=1-2 nm which is significantly smaller than typical surface-bound antibody size (˜10 nm), for example, which seriously affects the possibility to sense target biomoleucles. For example, in case of serum, the ion concentration needs to be significantly decreased which might influence the biological events, or shorter bioreceptors have to be employed.

Electrostatic control of the Debye screening length at the BioFET electrolyte-oxide interface (EOI) was recently suggested in various studies. The protonation of the amphoteric sites by the solution yields a surface charge density (σ₀) which depends on the solution acidity. The interactions at the oxide-solution interface are described by the site-binding model. To force local charge neutrality, an equivalent counter-charged solvent ions are adsorbed on the EOI, resulting in the appearance of the double layer. De facto, the problem of screening length is most severe at the double layer. The concentrations of ions at a distance x from the EOI are defined by the Boltzmann distributions:

$${n}_{+} = {n}_{+ , B} exp ( - \frac{{z}_{+} q ψ ( x )}{k T} ) and \\ {n}_{-} = {n}_{- , B} exp ( \frac{{z}_{-} q ψ ( x )}{k T} )$$

where n_{+,B} and n_{-,B} are the positive and negative bulk ion concentrations, ψ(x) is the electric potential, and q, k and T have their conventional meaning. Correspondingly, the 1D Poisson-Boltzmann equation is

$$\frac{{d}^{2} ψ ( x )}{d {x}^{2}} = - \frac{q}{ε} {\sum }_{i} {n}_{B , i} {z}_{i} exp ( \frac{- {z}_{i} q ψ ( x )}{k T} ) ,$$

where ε is the relative electrolyte permittivity. For EOI surface potential ψ₀<kT/q, the double layer adheres to the Debye-Huckel model and the co- and counter-ions concentrations are linear with the electric potential and therefore a surplus of counter-ions forces an equivalent lack of co-ions. On the other hand, according to the Gouy-Chapman model, ψ₀>kT/q, the population of counter-ions is substantially greater. The Gouy-Chapman approximation is more relevant in the context of BioFETs, as it conforms to ψ₀ values for applicable dielectrics in a considerable pH range and ionic strengths. Hence, the double layer total ion concentration (n₀) is considerably greater than n_{B} under the Gouy-Chapman approximation. Also, the integration of the one-dimensional Poisson-Boltzmann equation for relevant symmetric and asymmetric electrolyte produces the Grahame equation which sets the affinity between n₀ and σ₀ as Σᵢn₀ᵢ=Σᵢn_{Bi}+2πσ₀²/εkT, where i counts the ion species. The Grahame expression suggests that n₀ is always higher than n_{B} and the surplus concentration depends solely on σ₀.

The Poisson-Boltzmann equation accounts for the electrostatic behaviour while other phenomena, i.e., e.g., steric effects and dielectric decrement, affect the double layer kinetics as well. However, all these phenomena also show n₀>>n_{B}. Therefore, the electrostatic potential distribution and the double layer total ion concentration are independent of n_{B} close to the interface and the surplus ions near the interface entail an appreciable reduced λ_{D}. Therefore, the maximum screening takes place at the EOI and diminishes with the distance from EOI.

In the below, a Meta-Nano-Channel (MNC) BioFET is suggested to address the ‘Debye challenge’ of the BioFET technology. The MNC BioFET comprises of six independent gates which control the screening length at the double layer, and the position/shape/size of the conductive channel in the BioFET. The presence of multiple gates allows to electrostatically decouple the solution double layer from the conductive channel and the possibility to manipulate the screening length at the solid-solution interface without affecting the transduction performance of the BioFET.

Examples of device fabrication and geometry. The MNC BioFET were fabricated using the mass production Tower Semiconductor RF CMOS SOI platform. The devices are formed in the thin device layer of the SOI (silicon on isolator). The 145 nm silicon device layer is located on a 0.4 μm buried oxide (BOX) layer of a 200 mm wafers. The device layer has an average of ˜3×10¹⁷ cm-³ phosphorous doping with a certain gradient from the top to bottom interfaces. Four electrodes are formed in the device layer. Source and drain N⁺ regions are strongly doped with Arsenic (7×10¹⁹ cm⁻³).

Two lateral P⁺ gates (JFET-like) are implanted with Boron 2×10^{2°} cm-³. The P⁺ gates are formed in a self-aligned way using 200 nm Polysilicon over a 5.5 nm gate oxide. The same polysilicon (P⁻ doped) layer is used to form two transverse gates adjacent to the source and drain regions.

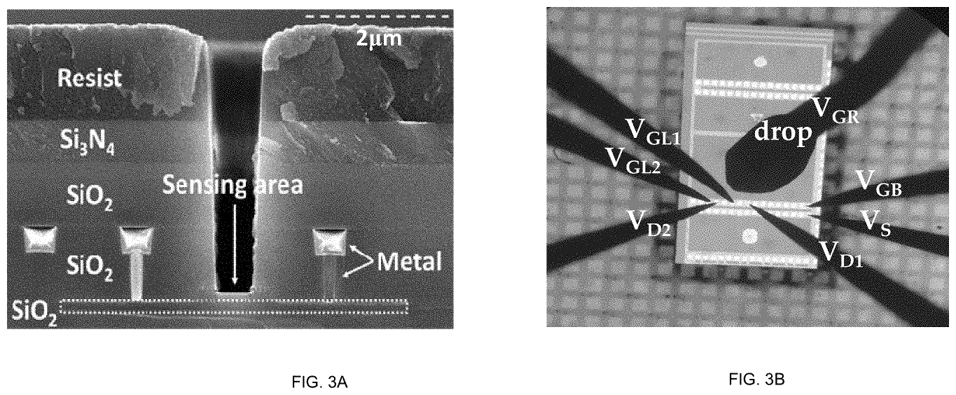

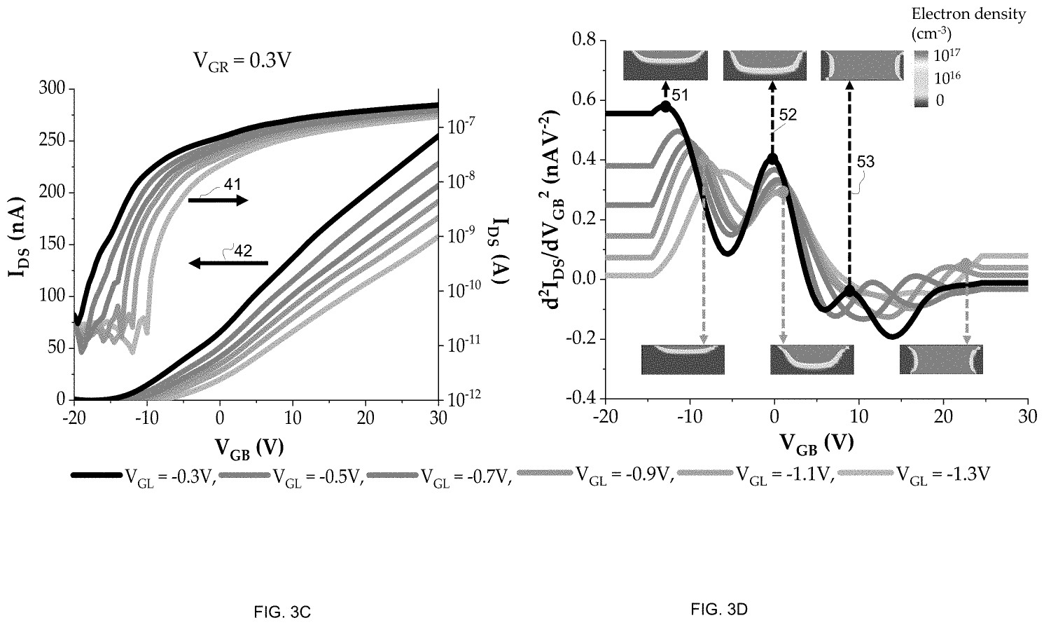

The channel length is 10 μm and the space between the P⁺ diffusion regions ranges from 0.5 to 1 μm for different device splits. A trench having a width of 0.6 μm is etched in the end of the process flow using an additional CMOS mask, as shown in FIG. 3A. The etch stops at the Polysilicon layer and the Polysilicon is then removed over the channel exposing the surface of the gate oxide. The Source/Drain and lateral gate electrodes are connected to pads at the surface of the device.

Electrical measurements. The current-voltage curves are measured using a probe station and a Keysight B1500 Semiconductor Parametric Analyzer. A 1 μl PBS of 10 mM pH7 droplet is applied on the chip active area (see FIG. 3B sensing area). The layout of the device does not allow the droplet to reach the electric pads. The droplet was also far from the edges of the chip (FIG. 3B). The drop is biased with a commercial Ag/AgCl reference electrode (ALS Co., Ltd).

Surface modifications and surface characterization. Silicon samples with a native oxide layer are cleaned by sonication in ethyl acetate, acetone and 2-propanol for two minutes each. The samples are then rinsed in deionized (DI) water and then put in piranha solution (7:3 H₂SO_{4:}H₂O₂) at 70° C. for 25 minutes. Samples are then rinsed with copious amounts of DI water and dried under a clean nitrogen stream. 3-aminopropyl trimethoxysilane (APTMS) solution was prepared as 1% v:v in methanol. The dried samples are placed in vials containing APTMS solution for 3 hours and then sonicated three times for three minutes in methanol. The samples are then transferred to DI water for 24 hours to induce hydrolysis and then dried and placed in an oven for 1 hour at 120° C. for curing. Hydrolysis is assumed to release the amine moieties from interactions with surface silanol groups of the APTMS molecule, thus releasing the amine moiety to extend away from the interface. Curing is suggested to stabilize the covalent bonds between the silane molecules and the oxide of the surface. The next step towards formation of a silicon-based biosensor for the specific detection of PSA as a biomarker is to modify these surfaces with glutaraldehyde crosslinker, which serves to anchor the anti-PSA antibodies. The surfaces are immersed in 0.5% aqueous solution of glutaraldehyde for one hour, to achieve an aldehyde-terminated surface. In the steps that followed, the surfaces are immersed in 10 μg/ml solution of anti-PSA, produced in rabbit, in 0.1 M PBS, pH 7.4 overnight. This strategy is based on the common knowledge that antibodies are typically immobilized to aldehyde-terminated surfaces based on the reaction between amine moieties of the antibody and the aldehyde group¹⁶. Surface characterization was performed with electrochemical impedance spectroscopy (Palmsens 4, Palmsens Inc.), atomic force microscopy (Multiview 4000, Nanonics Imaging Inc.) and spectroscopic ellipsometry (J.A. Woollam Alpha-SE Ellipsometer).

Numerical calculations. Sentaurus Device tool by Synopsys is employed for the three-dimensional device calculations. The Poisson and continuity equations are solved at every point. The device calculations account for doping-dependent mobility. The 1:1 electrolyte is emulated as an intrinsic semiconductor with a permittivity of 80 and an energy bandgap of E_{g}=1.5 eV to ensure the fulfilment of (E_{g}/2−qΨ)>>kT to validate the Boltzmann approximation in electrolytes. The semiconductor hole (p) and electron (n) concentrations are adapted to emulate the positive and negative ion densities: p=n=N_{Av}c₀×10⁻³ cm⁻³, where c₀ is the solution ionic strength. The effective density of states in the conduction (N_{C}) and the valence (N_{V}) bands are considered: N_{C}=N_{V}=ne^{E}^{_{g}}^{/2kT}=pe^{E}^{_{g}}^{2/kT}. The maximum mobility of holes and electrons are μ^{p}ₘₐₓ=4.98×10⁻⁴ cm²V⁻¹s⁻¹ and μⁿₘₐₓ=6.88×10⁻⁴ cm²V⁻¹s⁻¹, respectively, to emulate the behaviour of Na⁺ and Cl⁻ ions in NaCl solution. The surface potential ψ₀ at pH 7 and dissociation constants for SiO₂ are taken from literature, as well as the corresponding

$${σ}_{0} = q {N}_{s} ( \frac{{a}_{{H}_{s}^{+}}^{2} - {K}_{a} {K}_{b}}{{K}_{a} {K}_{b} + {K}_{b} {a}_{{H}_{s}^{+}} - {a}_{{H}_{s}^{+}}^{2}} )$$

where Nₛ is the fixed number of surface sites per unit area, a_{H}_{ₛ}_{⁺}² is the surface proton activity and Kₐ and K_{b} are the surface dissociation constants. 3D numerical calculations are also performed for the MNC BioFET accounting for the presence of the solution as described above.

### First Results and Discussion

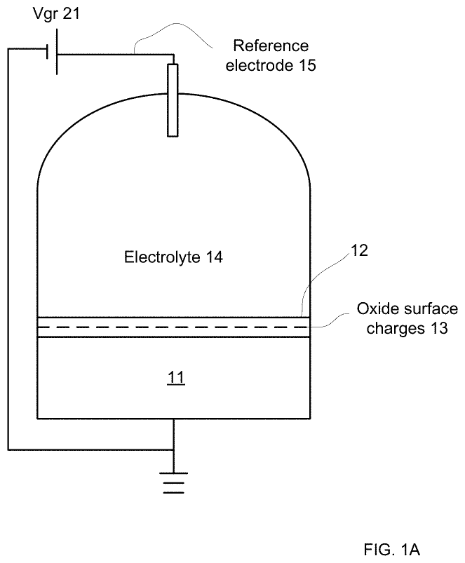

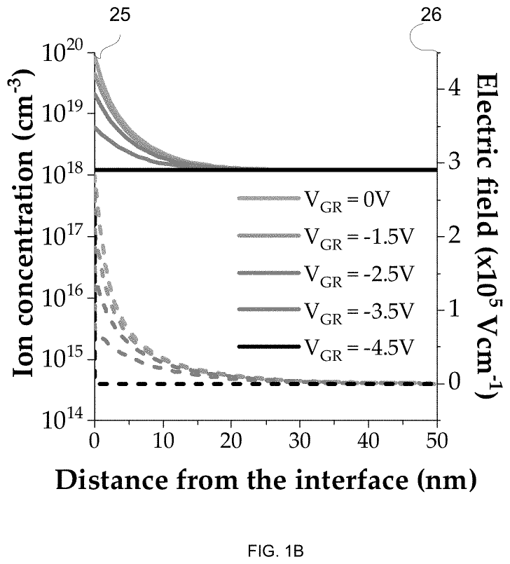

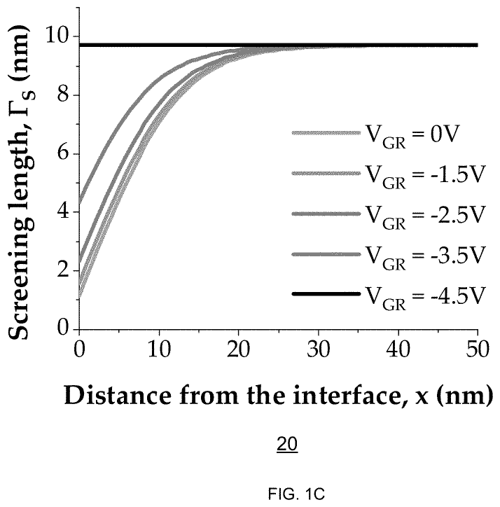

Ion concentration, electric field, pH level and Debye length at the vicinity of EOI are different from the values in the bulk solution away from the interface. A numerical example is presented in FIGS. 1A-1C. FIG. 1A shows a 100 nm thick p-type (Boron, 10¹⁶ cm⁻³) silicon layer 11 with a 6 nm SiO₂ gate dielectric 12 exposed to a 1 mM buffer solution. The presence of −1.4×10¹³ cm⁻² amphoteric sites at the gate dielectric-solution interface is considered. The solution is biased using a reference electrode 15 (fed by V_{GR} 12) with respect to the grounded silicon layer 11 (source electrode). FIG. 1A also illustrates oxide surface charges 13. FIG. 1B presents the distributions of the electric field (26) and ion concentration (25) in the solution as a function of distance from the gate dielectric-solution interface for different values of V_{GR}. Clearly, the formation of a double layer at the gate dielectric-solution is evident with markedly different values, as compared with bulk values. The surface electric fields reach values of 10⁵ V/cm in contrast with the nulled bulk electric field, and the surface ion concentration is almost two orders of magnitude higher than the bulk concentration. The difference between surface and bulk values also influences the Debye length: for 1 mM solution the Debye length at the bulk is almost 10 nm whereas the surface Debye length drops to ˜1 nm. This is of course critical to biosensing as this implies that events occurring beyond 1 nm away from the surfaces are fully screened and sensing is problematic. FIG. 1C includes graph 20″ that illustrates the screening length versus the distance from the interface for different values of V_{GR} (0, −1.5, −2.5, −3.5, and −4.5 Volts). This challenge can be resolved using V_{GR} as shown in FIGS. 1B and 1C. With the assumed parameters, applying V_{GR} can null the double layer and maximize the Debye length at the surface to its bulk value. The example shows how the Debye length limitation could be mitigated (for stronger electrolytes). However, V_{GR} biasing concurrently affects both the double layer and the conductive channel (via band bending at the silicon/gate-dielectric interface) since in steady state conditions charge neutrality must be maintained across the solution-solid interface. Thus, it is practically impossible to simultaneously apply V_{GR} for double layer optimization and have a measurable channel in the device layer of the BioFET.

In the following a method is suggested to overcome this challenge and decouple the double layer from the conductive channel.

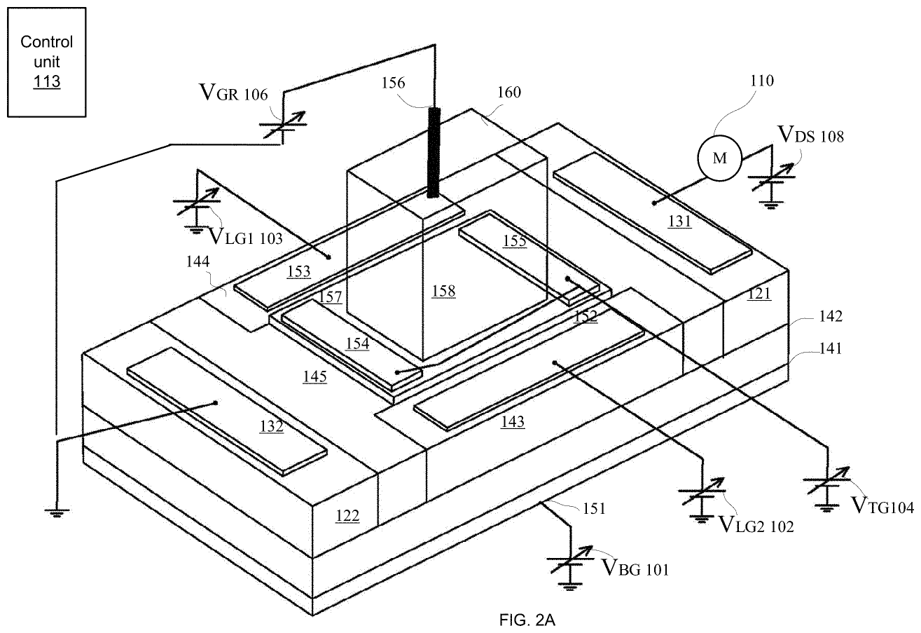

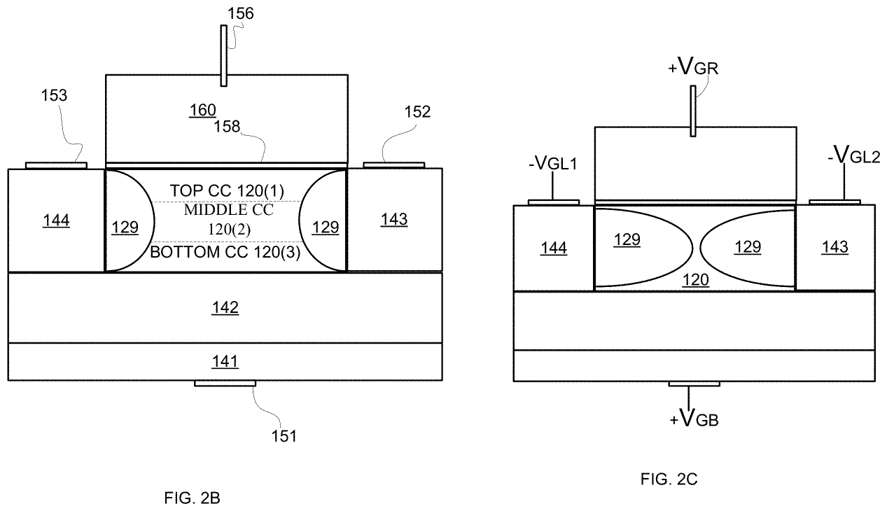

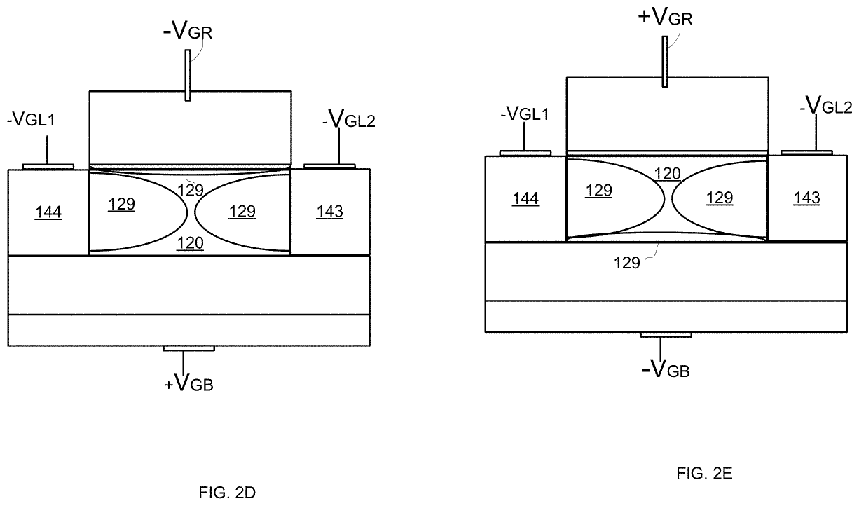

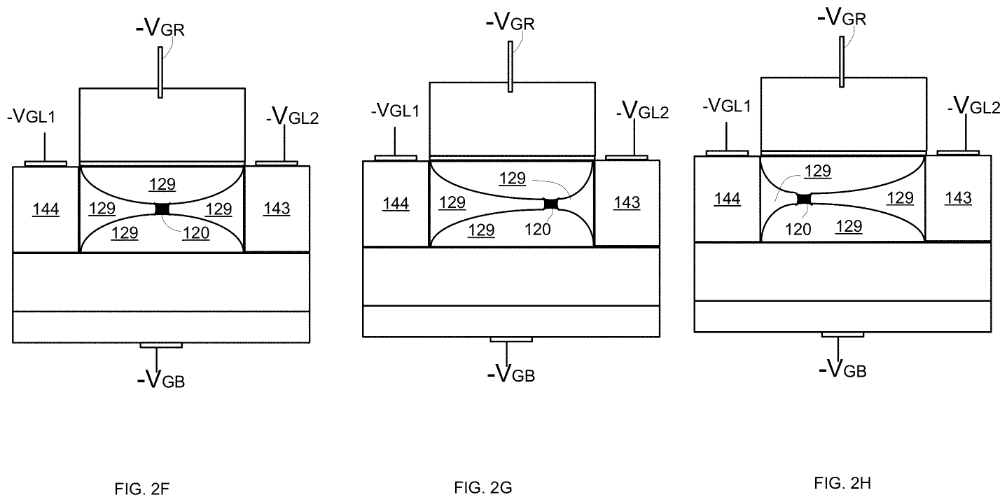

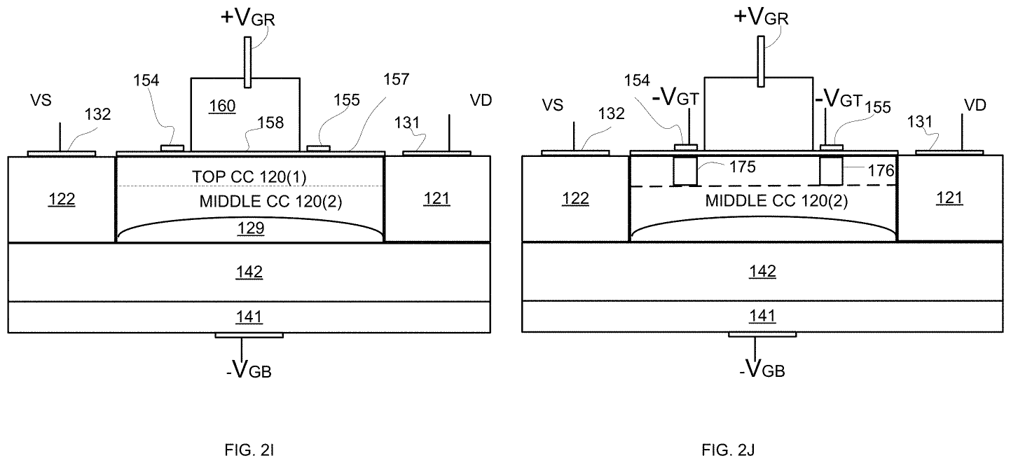

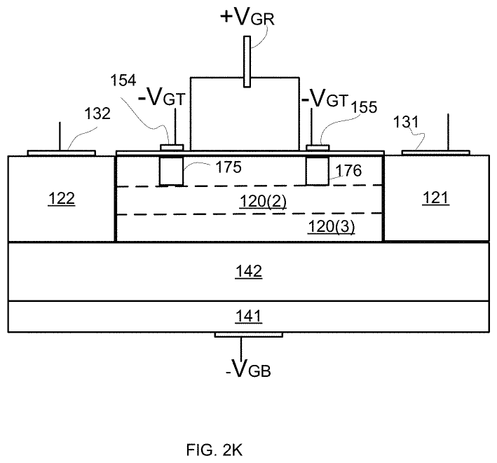

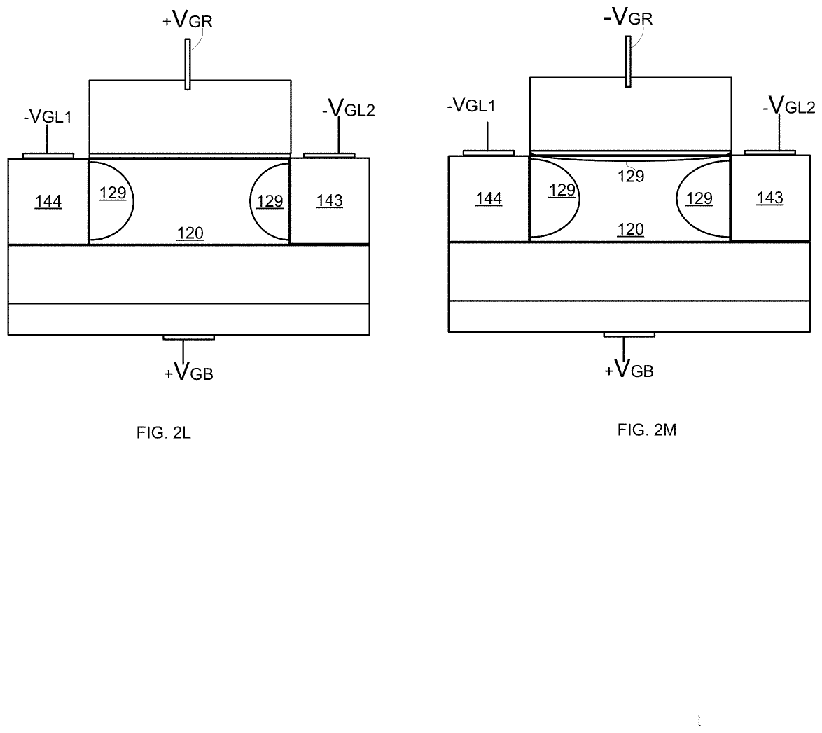

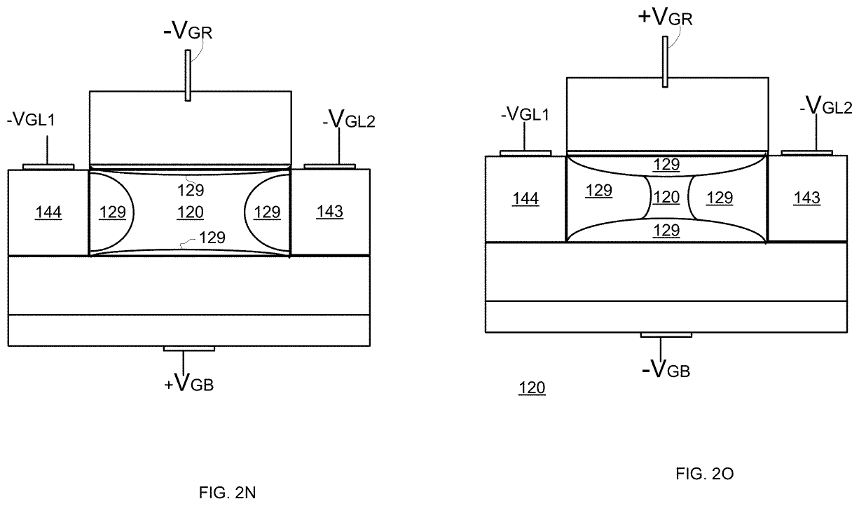

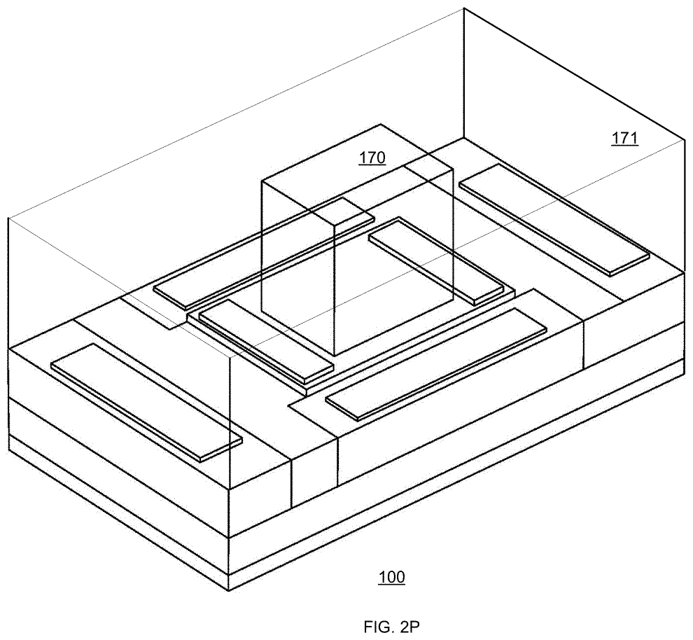

FIG. 2A illustrates of the MNC BioFET 100 which is based on a silicon-on-insulator (SOI) technology. In order to realize a label-free and specific MNC BioFET the gate oxide is modified with specific receptor molecules to form the active sensing area 158 (the receptor molecules are not reflected in the illustration), and directly below the active sensing area is the active device layer (ADL) 145. The degenerated n-type source and drain regions (122 and 121 respectively) define the length of the conductive channels. The conductive channel of the MNC BioFET is an accumulation-type channel composed of electron majority carriers. Six gates determine the electrostatic potential distribution in the ADL: top reference electrode gate (fed by V_{GR} 106), a backgate 151 (fed by V_{GB} 101), two lateral gates 152 and 153 respectively (fed by V_{GL1} 103 and V_{GL2} 102) and two transverse gates 154 and 155 (fed by V_{GT} 104). The width of the channel is defined by p-n junctions located on both sides of the ADL. The p-n junctions act as the lateral gates of the MNC BioFET. Reverse biasing of the p-n junctions will deplete the ADL from both sides and define the width of the conductive channels. FIG. 2A also illustrate oxide region 142, substrate 141, source contact 132, semiconductor region 122 below source contact, drain contact 131, semiconductor region 121 below drain contact, semiconductor regions 143 and 144 below the two lateral gates.

FIGS. 2B-2O are example of cross sectional views of the MNC BioFET 100. Some of the reference numbers that appear in these figures were not mentioned above and include—conductive channel 120, top conductive channel 120(2), middle conductive channel 120(2), bottom conductive channel 120(3), depletion region 129, and semiconductor regions 175 and 176 below the two transverse gates.

FIG. 2A illustrates the MNC BioFET which is based on a silicon-on-insulator (SOI) CMOS technology. In order to realize a label-free and specific sensing, the MNC BioFET active area is modified with specific receptor molecules (not shown). Immediately below the active sensing area is the active n-type doped SOI area (active device layer—ADL), where the electrostatic potential distribution is defined by the biasing of six gates. These gates (described below) permit the formation of various conductive channels of different sizes, shapes and locations. The conductive channels of the MNC BioFET are accumulation-type channels , with electrons being the charge carriers.

The degenerated n-type source and drain regions define the length of these channels. Six gates surround the active area of MNC BioFET: top reference electrode gate (V_{GR}), a backgate (V_{GB}), two lateral gates (V_{GL2}, V_{GL2}) and two transverse gates (V_{GT}). The width of the ADL is defined by the p-type regions which form p-n junctions on both of its sides. These p-n junctions form the lateral gates of the MNC BioFET. FIG. 2B presents cross-section half way between source and drain of an unbiased MNC BioFET. The presence of three conductive channels is apparent and marked in the figure: a top channel, a middle channel and a bottom channel. The biasing of the surrounding gates determines which channels are dominating the total conductance. Reverse biasing of the lateral gates p-n junctions will deplete the ADL from both sides and defines the width of the middle conductive channel (FIG. 2C). Additional negative biasing of V_{GR} depletes also the top ADL interface which concludes the formation of two channels, namely, a middle channel and a bottom channel, as presented in FIG. 2D. Alternatively, negative biasing of VGB depletes the bottom ADL interface and allows only the formation of top and middle channels (FIG. 2E). Simultaneous negative biasing of V_{GR}, V_{GB} and V_{GL} allows the formation of a single middle channel, as shown in FIG. 2F. Asymmetric biasing of V_{GL} determines the lateral location of the middle channel as shown in FIG. 2G and FIG. 2H.

The additional two transverse gates are present on top of the gate dielectric parallel to the source and drain, as shown in FIG. 2A. The transverse gates are p-type polysilicon and form metal-oxide-silicon (MOS) capacitors with respect to the ADL.

The transverse gates may be insulated from the solution and form metal-oxide-silicon (MOS) capacitors with respect to the ADL. The transverse gates may decouple the double layer from the conductive channel.

The transverse gates can eliminate the formation of a top channel as the negative bias will deplete or invert the ADL directly below the transverse gates.

The transverse gates permit the independent control of the electrostatic conditions at the double layer by the reference electrode without affecting the conductive channel.

For any biasing of the reference electrode the formation of a top conductive channel is prohibited once the transverse gates are negatively biased which means that the active SOI regions just below the transverse gates are either depleted or inverted, i.e. populated with hole minority carriers, and in this way prevent the formation of a top conductive channel even for positive biasing of the reference electrode

FIG. 2K illustrates a source-to-drain cross-section (marked with V_{S} and V_{D}) showing the top, middle and bottom channels. FIG. 2I shows the same cross-section with negative biasing of V_{GB} and the activation of the middle and top channels. FIG. 2I shows additional negative biasing of V_{GT} which induce depletion areas below the transverse gates that prohibit the formation of a top channel. Therefore, only the middle channel contributes to the MNC BioFET conductivity.

FIG. 2L shows the cross-section for an unbiased MNC BioFET in which the formation of three conductive channels is recognized: a bottom channel, a middle channel and a top channel. The depleted areas at the sides of the ADL are due to the built-in potential of the lateral p-n junctions. Negative biasing of the backgate depletes the bottom part of the ADL and only the middle and top channels are permitted (FIG. 2M).

Similarly, negative biasing of the top reference electrode results in the formation of bottom and middle channels, as shown in FIG. 2N. Negative biasing of V_{GR} and V_{GB} allows the formation of only the middle channel (FIG. 2O). FIG. 2P illustrates the oxide 171 in which the compartment 170 with fluid is formed.

FIG. 3A presents a scanning electron microscopy (SEM) cross-section of the MNC BioFET half way between the source and drain in which the various regions are shown and labelled.

FIG. 3B presents an optical microscope image of the chip and the probes connecting to the various gates and contacts of the BioFET.

FIG. 3C presents current-voltage (I-V) curves of I_{DS} vs. V_{GB} for various values of V_{GL} −0.3, −0.5, −0.7, −0.9, −1.1 and −1.3Volts) both on the linear and logarithmic scales. Note that the built-in voltage of the p-n junctions of the lateral gates is in the range of 0.5 V for the relevant doping levels, and therefore positive V_{GL} is avoided to prevent current flow through the lateral p-n junctions. As expected, lower biasing of V_{GL} concludes greater depletion areas and therefore a decrease in current is recorded as the reverse biasing of V_{GL} increases.

FIG. 3D shows the extracted second derivatives for the I_{DS}-V_{GB} curves of FIG. 3C. A peak in the graph of the second derivative marks the formation of a conductive channel, and the location of the peak is used to determine the threshold voltage. There are three peaks 51, 52 and 53. The formation of three distinct channels is observed. For high negative values of V_{GB} the ADL is fully depleted and no channel is allowed. As V_{GB} increases the depletion region retreats from the top area of the ADL and the top channel is observed. As V_{GB} is further increased, the middle channel and afterwards the back channel are formed. In this manner, the functionality of the MNC BioFET can be described as triggering of three different channels, all the channels are controlled by the backgate but each having its own threshold voltage (V_{T}). For more negative V_{GL} the overall ADL becomes more depleted and therefore results in a shift in V_{T}, or shift of the IDS second derivative peak to the right, towards higher values for all the three channels. Also, the magnitude of the second derivative reflects the curvature of the various I-V curves. Note that the top channel exhibits the highest curvature which decreases for the middle and bottom channels. Finally, the insets in FIG. 3D present the numerically calculated cross-sections of the experimental MNC BioFET half way between the source and drain, showing the electron density distribution in the ADL for different biasing conditions.

Next, it is demonstrated how to govern the Debye screening length using the MNC BioFET in order to manipulate the electrostatic potential, and the subsequent formation of the channel configuration inside the ADL.

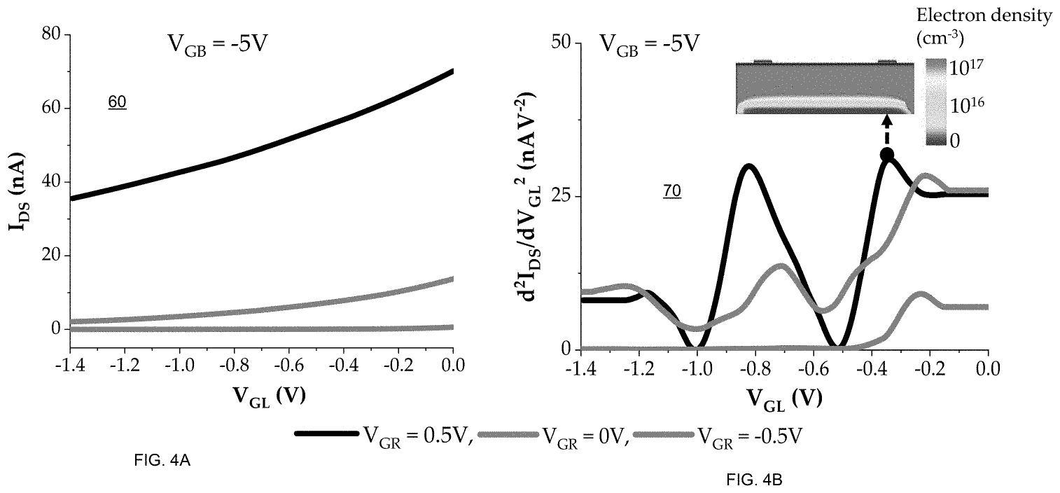

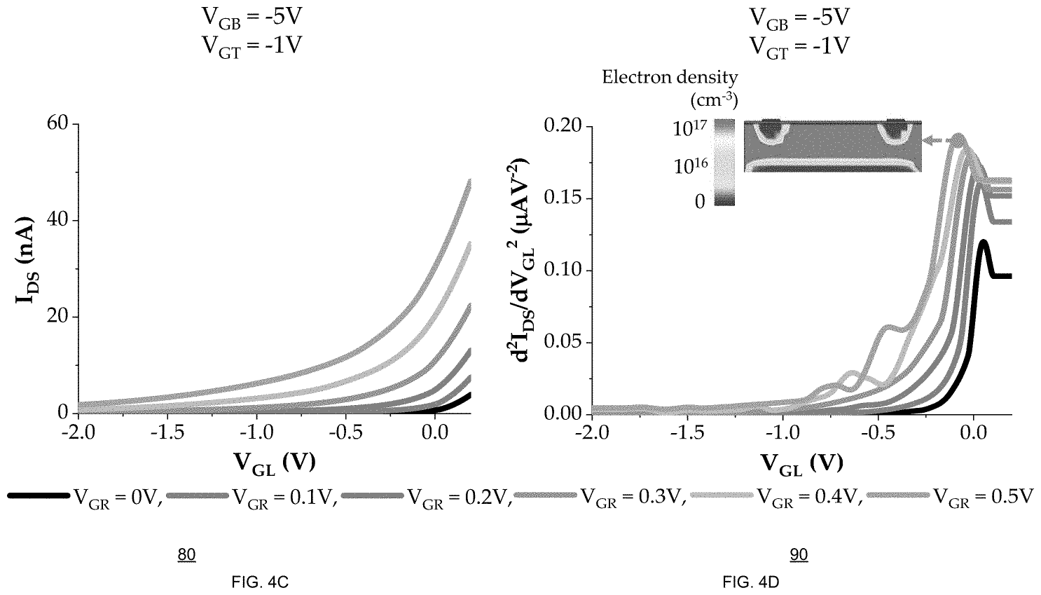

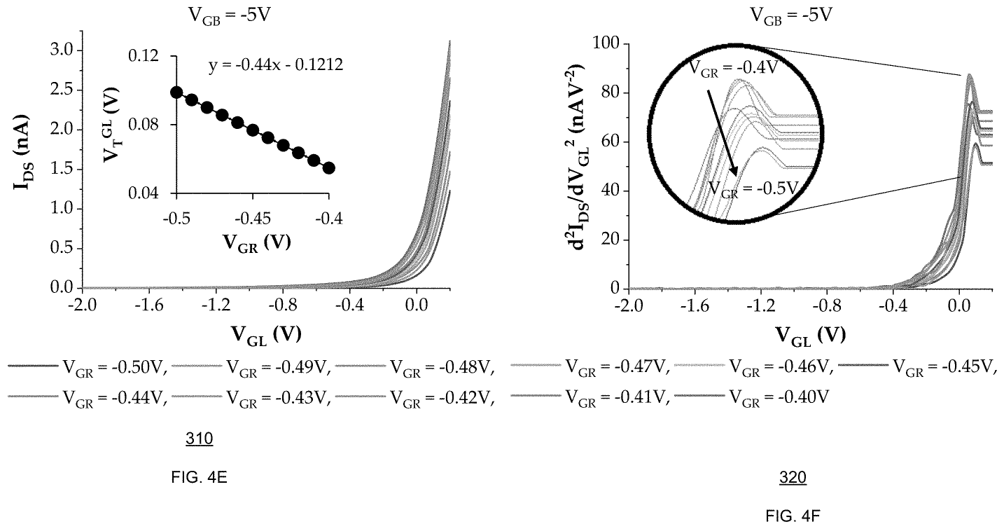

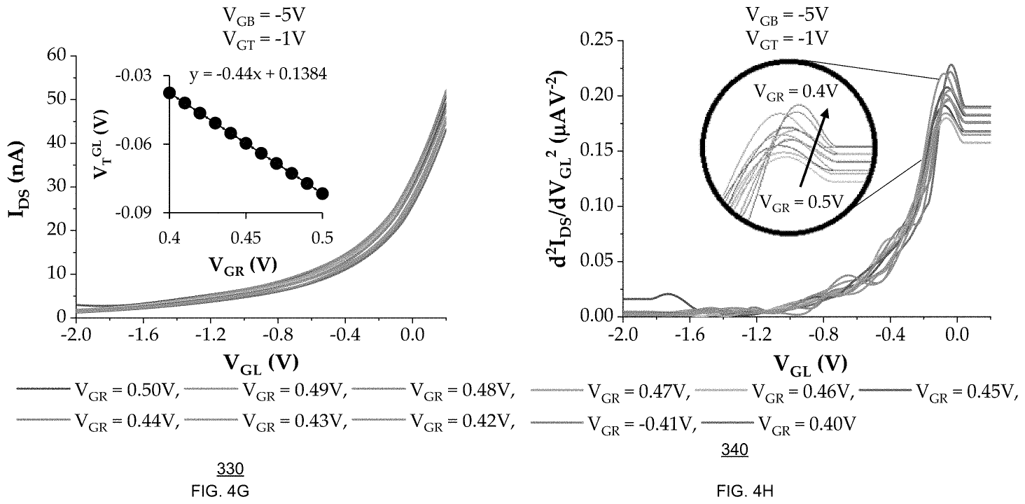

FIGS. 4A-4H illustrate graphs 60, 70, 80, 90, 310, 320, 330 and 340.

FIG. 4A presents I_{DS}-V_{GL} curves for V_{GR}=−0.5 V, 0V, 0.5 V. V_{GB} is biased at −5V to eliminate the formation of a bottom channel and V_{DS} is set to 0.1 V. FIG. 4B shows the respective second derivative curves indicating how V_{T}^{GL} shifts towards higher values for negative V_{GR} as the latter depletes the active SOI region. Importantly, for V_{GR}=0 V and 0.5 V the formations of both top channel (left peak) and middle channel (right peak) are evident, while for V_{GR}=−0.5 V only the formation of the middle channel is allowed. This suggests that the double layer can be negatively biased to null the solution surface electric fields and maximize the Debye screening length (for example in the case of positively charged amphoteric sites such as with Al₂O₃ at pH7). Negative V_{GR} ensures that the top channel is closed and current is conducted only through the middle channel. The inset of FIG. 4B presents a source-to-drain cross section of the MNC BioFET showing the numerically calculated electron density distribution in the ADL. The depleted lower part of the SOI active region is due to the negative biasing of the backgate, and the formation of middle and top channel is now permitted, as illustrated in FIG. 2H.

In the case in which positive V_{GR} is required to null the surface electric fields to maximize the surface Debye length (for example, for negatively charged amphoteric sites, such as in the case of Si₃N₄ or SiO₂ interfacing with a pH7 electrolytes), the challenge is more acute, as positive V_{GR} implies accumulated front interface and hence the formation a top channel. This means that any biasing of the double layer, to affect the surface Debye length, will also affect the conductive channel which depends both on top and middle channels. This imposes a constraint on the conductive channel, as such biasing might imply conditions that are not favourable for sensing. The biasing of the double layer for the optimization of Debye length should not affect the conductive channel. We employ V_{GT} in order to decouple the biasing of the double layer from the conductive channel.

FIG. 4C presents I_{DS}-V_{GL} for positive values of V_{GR} with the additional biasing of V_{TG}=−1 V and V_{DS}=0.5 V, and FIG. 4D shows the respective second derivatives. Note the appearance of only a single peak which reflects the formation of the middle channel as the left peak associated with the top channel is now removed. Evidently, the generation of the top channel is prohibited by the reverse biasing of the MOS capacitors below the transverse gates, and only the formation of the middle channel is possible. This is of crucial importance as it implies that the top interface does not contribute to the conductive channel, and hence the conditions at the double layer can be defined independently of the conducing channel. V_{GR} can be set to null the double-layer and achieve bulk Debye length at the solid-solution interface. Still, note that for the higher V_{GR} values the top channel is not fully eliminated as IDs is not nulled even for V_{GL}=−2 V. However, the contribution of the top accumulation is negligible (which is demonstrated in the following) as can be ascertained from the small peaks on the left. Therefore, biasing the reference electrode forces band bending at the silicon/SiO₂ interface to maintain charge neutrality across the solid-solution interface. However, whether the Si/SiO₂ interface is now accumulated/depleted or inverted does not in any way contribute to the conductive channel as only the middle channel is connected to source and drain. The inset of FIG. 4D presents a source-to-drain cross section of the MNC BioFET showing the numerically calculated electron density distribution in the ADL. The depleted lower part of the ADL is due to the negative biasing of the backgate. The top area of the ADL is accumulated but the top channel is prohibited due to the depletion areas below the transverse gates, and only the formation of the middle channel is now permitted, as illustrate in FIG. 2I.

The above demonstrates how the MNC BioFET ensures that neither accumulated or depleted Si/SiO₂ interface generates a top channel. Nevertheless, it is important for the middle conductive channel to have sensitivity towards front surface potential variations, that are induced by biological interactions at the MNC BioFET active sensing area. This sensitivity is explored next and presented in FIGS. 4E-4H. FIG. 4E shows I_{DS}-V_{GL} for depleted front interface with V_{GR} biasing in the range of −0.4 V to −0.5 V. Note that for these biasing conditions the MNC BioFET middle channel has the shape of a nanowire (FIG. 2F) and hence the low currents. The inset in FIG. 4E presents dependency of V_{T}^{GL} on V_{GR} as extracted from the peaks of the 2^{nd} derivatives shown in FIG. 4F. The linear dependency of the V_{T}^{GL} on V_{GR} is demonstrated with a linear coefficient of 0.44 which implies that a 10 mV shift in the active sensing region will induce a shift of 4.4 mV in V_{T}^{GL}. FIGS. 4G and 4H show the corresponding data for accumulated front interface with V_{GR} biasing in the range of 0.4 V to 0.5 V. In this case, the sensitivity of the middle channel is more challenging as variations in the potential of the active sensing are, in-principle, more susceptible to screening by the electrons accumulated at the Silicon/SiO₂ interface. Still, as presented in FIGS. 4G-4H, the sensitivity of the middle channel to potential variations across the active sensing region is similar to the sensitivity presented in FIGS. 4E-4F for depleted top interface.

FIGS. 4A-4H reflect n-type silicon with an accumulation-type conduction and for negatively-charge amphoteric sites. However, one has to keep in mind that the surface charge changes with the inevitable surface modifications for the tethering of receptor molecules to the active sensing area. For example, surface chemical modification of SiO₂ gate oxide with 3-aminopropyl trimethoxysilane (APTMS), that is widely used as a linker molecule to bind antibodies to SiO_{2,} induces surface positive charge. In this case, positive V_{GR} needs to be applied in order to null the associated double layer. Still, positive V_{GR} will also induce accumulation of electrons at the Si/SiO₂ interface. Therefore, V_{TG} must be negatively biased in order to prevent the formation of a top conductive channel and in this manner decouple the DL from the conductive channel.

Debye screening length limitation is a fundamental challenge in biological sensing in solution based on BioFETs. In practice, the effective screening length at the EOI is inherently smaller than in the bulk solution as the ion population is significantly higher at the EOI. This renders the screening length challenge even more severe as the biological interactions takes place inside or at the close proximity to the EOI. One straightforward approach to overcome the EOI screening length is to bias the reference electrode with respect to substrate in order to achieve bulk Debye length at the EOI. However, biasing the reference electrode affects also the band bending at the BioFET silicon/gate-dielectric interface and hence the conductive channel.

The application demonstrated a MNC BioFET that provides decoupling of the double layer electrostatics from the electrodynamics of the conductive channel, and therefore allows an independent control of the DL. Both numerical calculations and experimental results of the MNC BioFETs fabricated in an industrial CMOS SOI technology confirmed the operation principles. We believe that the MNC BioFETs, that have all the advantages of conventional BioFETs and also additional ability to control the Debye layer and the conductive channel separately, are promising devices for specific and label-free sensing of biological analytes.

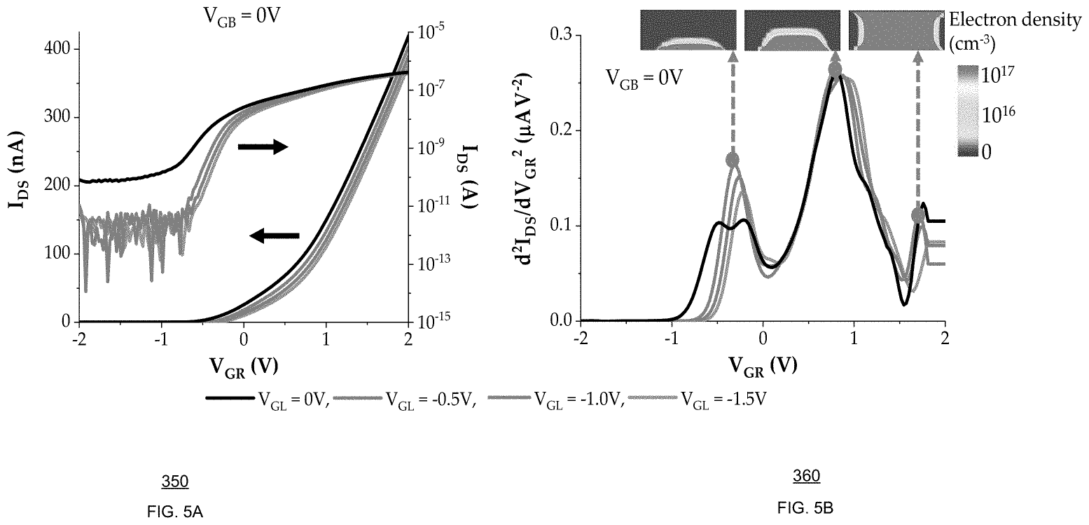

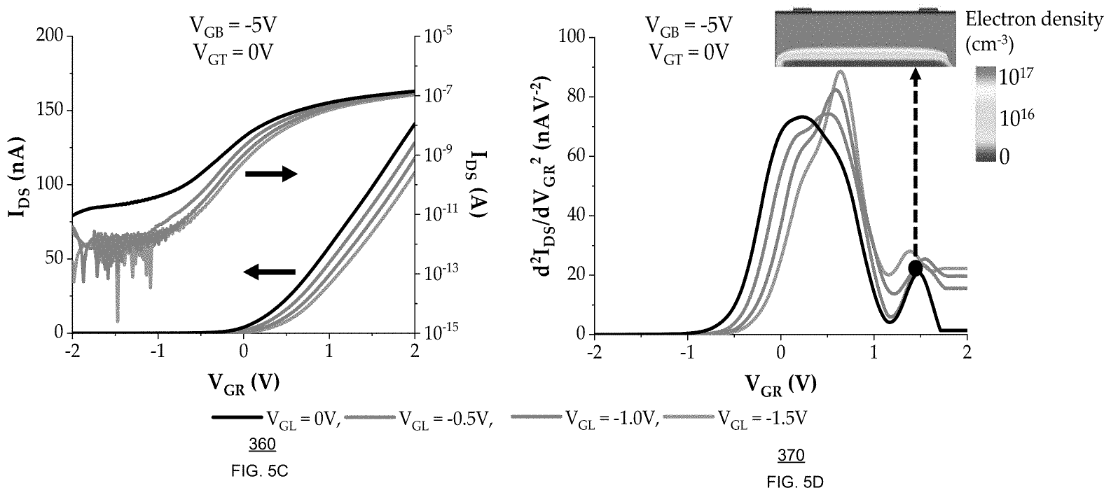

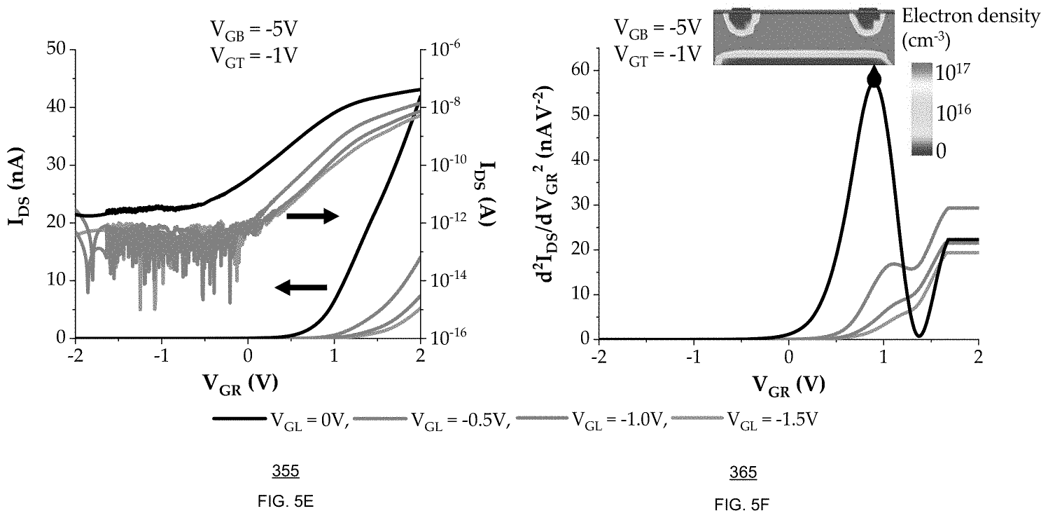

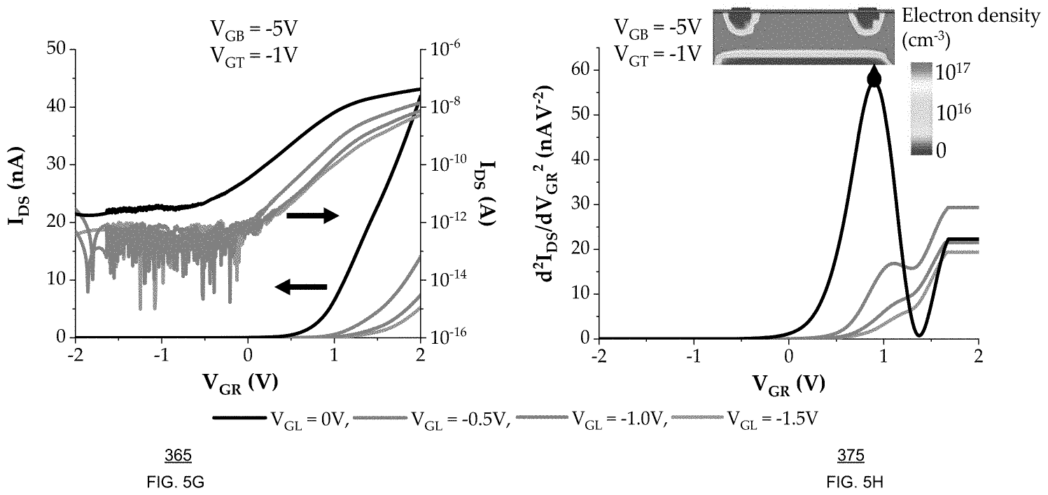

FIG. 5A shows current-voltage (I-V) curves presenting drain-source current (I_{DS}) vs. V_{GR} for various values of V_{GL}. The I-V curves are performed for three drops and each drop is measured three times; hence, each of the I-V curves reflects the population of nine measurements which clearly cannot be distinguish and mark the excellent repeatability of the MNC BioFET. FIG. 5B presents the respective second derivatives in which the three peaks reflect the formation of the three conductive channels and mark the threshold voltages. For a very negative V_{GR} the active SOI is totally depleted and no current/channels are formed. As V_{GR} increases the depletion retreats first from the bottom interface and permits the formation of the bottom channel. As V_{GR} further increases, the middle channel and the top channel are formed as well. FIGS. 5C and 5D present I_{DS}-V_{GR} curves for V_{GB}=−5 V and the corresponding second derivatives, respectively. The smaller current values, as compared with FIG. 5A, are evident which reflect the depleted bottom interface. As expected, for V_{BG}=−5V the bottom interface is depleted for all V_{GR} values and, therefore, the formation of the bottom channel is prohibited and the two second derivative peaks mark the triggering of the middle and top channels. Note, that the peak of the middle channel is now wider compared with FIG. 5B which reflects the difference in potential at the bottom part of the active SOI due to the shift of V_{GB} from 0 V to −5 V. FIGS. 5E and 5F present the I_{DS}-V_{GR} for V_{GB}=−5V and V_{GT}=−0.7 V and the second derivatives, respectively. An overall decrease in current compared with FIG. 5A and FIG. 5D must be noted, that reflects the additional biasing of V_{GT}. Importantly, the second derivative curves have only a single peak and therefore, for the full range of V_{GR}, only a single channel is formed. In this case, the top channel is also interrupted due to negative biasing of V_{GT} which prevents from a top channel to develop albeit the obvious accumulation of electrons at the top interface for positive V_{GR} values. FIGS. 5G and 5H are similar to FIGS. 5E and 5F only for lower V_{GT} values showing the larger depletion areas below the transverse gates and the full elimination of the top channel.

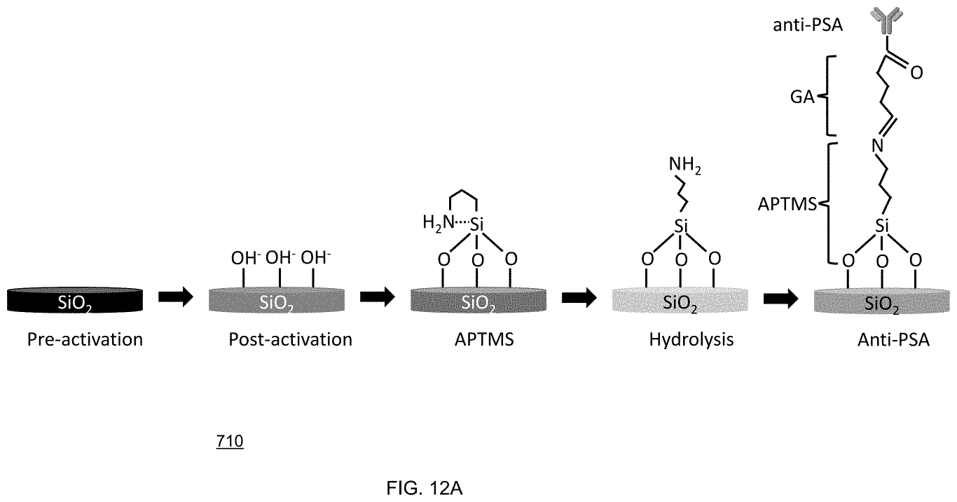

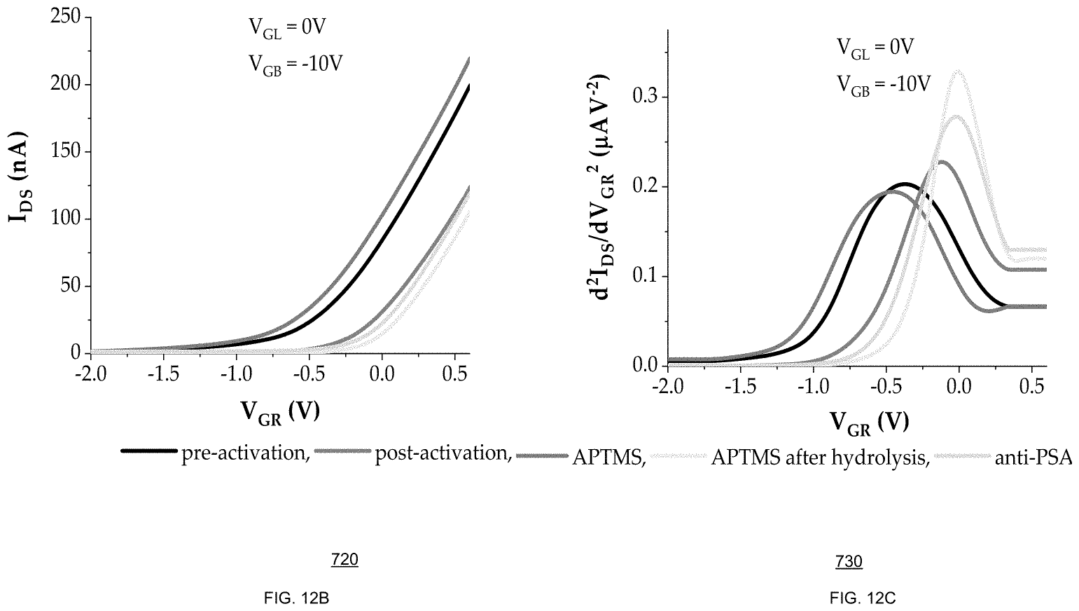

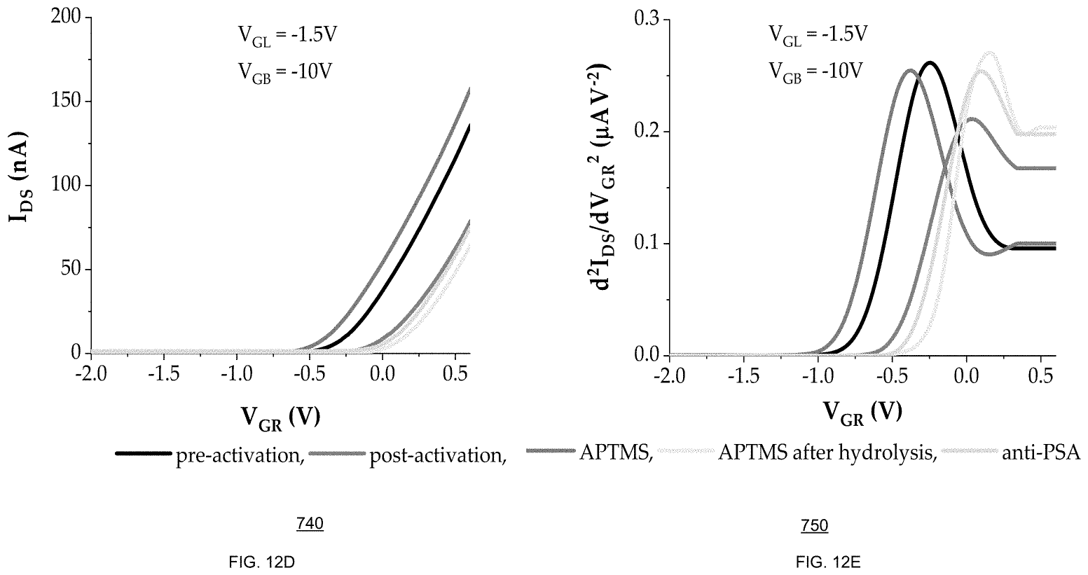

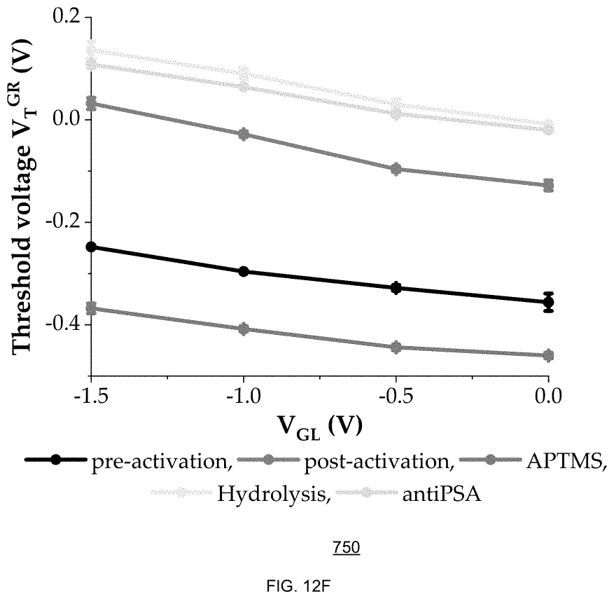

The MNC BioFET may be biofunctionalized for the purpose of specific and label-free detection of prostate specific antigen (PSA). To this end, anti-PSA antibodies are chemically tethered to the active sensing area. The different surface chemical treatments are described in the Methodology section and, in general, follow procedures reported previously. Briefly, the different steps of the modification are shown in FIG. 12A shows a process 710 that includes surface activation, surface chemical modification with APTMS molecules, hydrolysis and covalent tethering of the anti-PSA antibodies with a glutaraldehyde (GA) linker. The modifications were characterized using various methods including spectroscopic ellipsometry, atomic force microscopy (AFM), and electrochemical impedance spectroscopy (See SI§ 1).

FIGS. 12B-12F includes graphs 720, 730, 740, 750 and 760.

FIG. 12B shows the effect of the different chemical treatments on the I_{DS}-V_{GR} curves for V_{DS}=0.1 V, V_{GB}=−10 V, V_{GL}=0 V where each data point is the average of nine measurements.

FIG. 12B shows the corresponding second derivatives. Surface activation induces the formation of negative hydroxyl groups on the surface, and hence a significant increase in V_{T}^{GR} is measured. The subsequent surface modification with ATPMS molecules introduce additional positive charges, also as reported previously, and hence a decrease in V_{T}^{GR} is measured. Hydrolysis is known to release the amine moieties from interactions with surface silanol groups of the APTMS molecule. Therefore, releasing the positively-charged amine moiety that moves away from the interface¹⁵ effectively induces additional negative surface charges which result in V_{T}^{GR} increase. Finally, the covalent tethering of the anti-PSA with a GA linker incorporates additional positive charges and a small V_{T}^{GR} decrease is measured.

FIG. 12V presents the corresponding second derivatives in which the formation of a single channel is evident. Note that the top channel is closed for the selected range of V_{GR} voltages, and the back channel is closed due to the negative bias of V_{GB} and only the activation of the middle channel is permitted. FIG. 12D show similar I_{DS}-V_{GR} curves only for V_{GL}=−1.5 V, and FIG. 12E presents the corresponding second derivatives which reflects the activation of a single middle channel. Finally, FIG. 12F summarizes the shifts in V_{T}^{GR} for the different surface treatments and the different V_{GL} values where the data points are average values and the error bars are the standard deviation of nine measurements. Higher V_{T}^{GR} are measured for lower V_{GL} as negative V_{GL} implies a more negative ADL and hence higher V_{T}^{GR} is required to generate a channel of accumulated electrons.

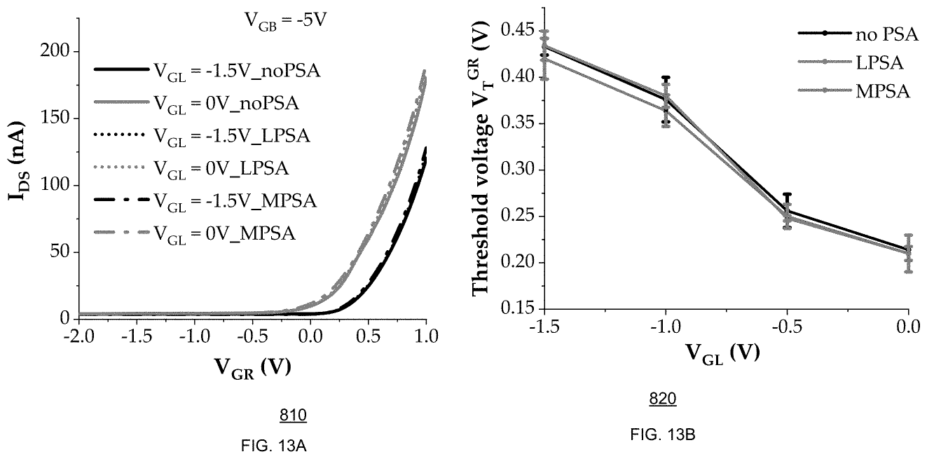

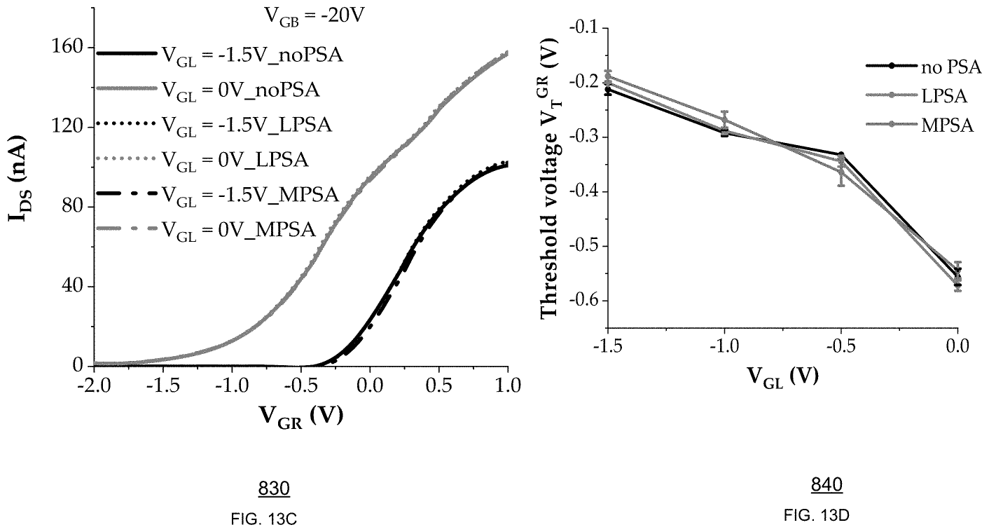

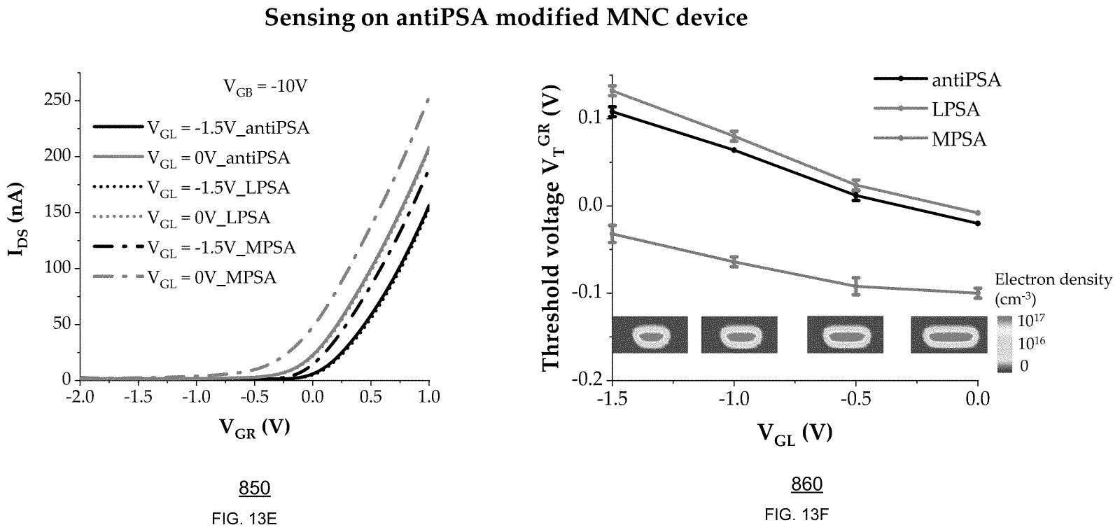

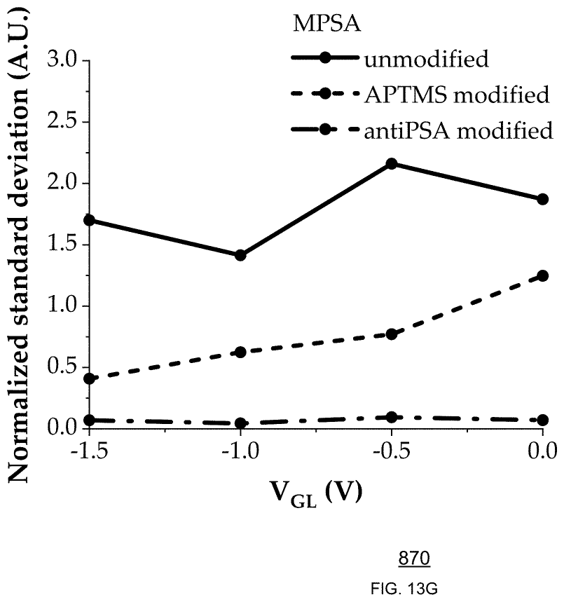

FIGS. 13a-12F includes graphs 810, 820, 830, 840, 850 and 860

FIG. 13A shows I_{DS}-V_{GR} curves before and after the introduction of 100 ng/ml and 1 μg/ml of PSA to an unmodified MNC device for V_{GL}=0 and −1.5 V , V_{DS}=0.1 V, V_{GB}=−5 V. The data points of the I_{DS}-V_{GR} curves reflect the average of nine measurements. FIG. 13B shows the dependency of V_{T}^{GR} on V_{GL} and the data points and error bars reflect the average and standard deviation of nine measurements. As expected, higher shifts in V_{T}^{GR} are measured for lower V_{GL} values. Clearly, the physical adsorption of PSA on the SiO₂ active sensing area does not affect the current for any of the biasing conditions. The experimental measurements are repeated for MNC device with active sensing area modified with APTMS are presented in FIG. 13C and FIG. 13D. Note the V_{T}^{GR} decrease relative to the unmodified MNC BioFET due to the introduction of positive surface charges induced by the APTMS layer, as discussed above (FIG. 12F).

The additional positive surface charges also allow the formation of a top channel for the higher V_{GL} values (SI§ 2). Similar to the measurements performed for the unmodified MNC device, the introduction of PSA on the APTMS-modified MNC device does not affect the current (V_{DS}=0.1 V, V_{GB}=−20 V). Lastly, specific and label-free sensing of PSA is pursued and the experimental measurements are repeated for an MNC BioFET modified with anti-PSA molecules. The results are presented in FIG. 13E and FIG. 13F for V_{GB}=−10 V and V_{DS}=0.1 V. As no shifts in V_{T}^{GR} are recorded for neither the unmodified nor the APTMS-modified MNC BioFETs, the data presented in FIG. 13F reflects specific and label-free sensing of PSA.

The data set suggests few interesting points. Firstly, V_{T}^{GR} increases upon introduction of 100 ng/ml of PSA and decreases upon the introduction of 1 μg/ml which could reflect different state of the anti-PSA/PSA complex. For example, the lower PSA concentration could result in the formation of sparse complexes that thermodynamically could be more tilted towards the active sensing area, whereas the higher PSA concentration could form more compact complexes that force a more upright configuration. It is very common in the literature to find descriptions of the receptor-analyte system in an upright vertical configuration normal to the surface of the active sensing area. Clearly, in such case any interaction between the target protein and the surface are excluded. Still, recent studies show that the adsorption of proteins on dielectric surfaces conclude primarily a horizontal configuration with the Fc and two Fab parts interfacing the substrate. Note, that horizontal configuration is apparent albeit the electrostatic repulsion between the dielectric surface and the target protein. The horizontal configuration is more probable in a sparse system in which effects of steric hindrance are less pronounced. Unlike the vertical configuration, the horizontal configuration can result in various molecule-dielectric interactions (or molecule interactions with various APTMS moieties, for example) that are completely absent in the case of the vertical configuration in which no direct interaction between the target protein and the surface are considered.

The horizontal configuration allows for various direct interactions of the target proteins, such as: 1) interactions with the dielectric amphoteric sites; 2) side-chain charge of amino acids exhibit differential adhesion to different materials; 12) strong binding is attributed to basic residues (His, Lys, Arg), and electrostatic interactions are considered as the dominant force binding peptides to the negatively charged surfaces) adsorption of surface-bound proteins to surfaces is favorable in terms of entropy and enthalpy. One mechanism describes how the free energy of adsorption is governed by high positive entropy which is due to the loss of organized water that hydrates the protein and the surface prior to adsorption. This indicates that one proton is exchanged upon adsorption. Clearly, all the above interactions which are expected for the low PSA concentration could yield variation in surface potential, and shift in threshold voltage, that is of the opposite polarity relative to shift recorded for the higher PSA concentration.

Another interesting observation is how the V_{T}^{GR} shift decreases with increasing V_{GL} where for V_{GL}=−1.5 V the V_{T}^{GR} shift is ˜130 mV and for V_{GL}=0 V V_{T}^{GR} shift is ˜80 mV (This trend is also evident for the data presented in FIGS. 13B, 13D).

The width of the conductive channel increases with V_{GL} increase (insets FIG. 13F), and therefore a direction correlation is set between channel width and shift in V_{T}^{GR} as narrower channel yields higher V_{T}^{GR} shift. One simple explanation could be the supposedly superiority of a ‘nanowire’ device over a planar device, as was suggested by others although in the current study the nanowire is ‘planar’ and not the conventional 12D physical nanowire. Moreover, for V_{GL}=−1.5 V only the middle channel is formed while for V_{GL}=0 V also a top channel is present (SI§ 2). This is surprising as it is expected that the top channel will be more sensitive to potential variations at the active sensing area (induced by biological interactions) compared with the middle channel as the top channel is physically closer to the biological interactions. The reason for the superior sensing performance of the middle channel could be due to the known 1/f noise related to slow surface states at the Si/SiO₂ interface which induce variations in both charge carrier mobility and carrier number. It is suggested that the sensing performance of the middle channel is less affected by these noise centres as it is further removed from the Si/SiO₂ interface. Finally, another possible mechanism for the enhanced sensitivity of the buried middle channel is that a buried channel has a larger lateral projection (or a larger ‘foot print’) of the active sensing area compared with a channel that is directly below the active sensing area.

Finally, the distribution of the data points for the anti-PSA-modified MNC BioFET, as reflected in FIG. 13F by the error bars, is markedly smaller than the corresponding distributions in FIGS. 13B and 13D.

FIG. 13G presents the standard deviation normalized by the threshold voltage shift due to the introduction of 1 μg/ml PSA for the populations in FIGS. 13B, 13D and 13F (See SI§ 2 for 100 ng/ml PSA). Also, note that the distributions in FIG. 13F are similar to the V_{T}^{GR} shifts for the various surface modifications in FIG. 12F.

Surface biofunctionalization by covalent binding provides the best stability towards temperature, flow rate, pH and ionic strength variations. Therefore, chemical adsorption reflects a more orderly and stable interactions which should manifest a higher repeatability and hence the small error bars of FIG. 12F. On the other hand, the larger error bars of FIGS. 13B and 13D suggest of the unstable and non-uniform physical adsorption of PSA on the unmodified and APTMS-modified MNC BioFET surface. Biomolecules bound to the sensor surfaces by physisorption often tend to folding, these are more susceptible to desorption and random orientation which result in lack of reproducibility. Therefore, continuing this line of argument, the small error bars of FIG. 12F suggest that the main adsorption mechanism of PSA is through chemical adsorption via specific interactions with the surface-bound anti-PSA molecules.

A correlation between the channel properties and the sensing signal is demonstrated and specifically it is shown how a nanowire-shaped channel which is shifted away from the Si/SiO₂ interface provides a superior sensing.

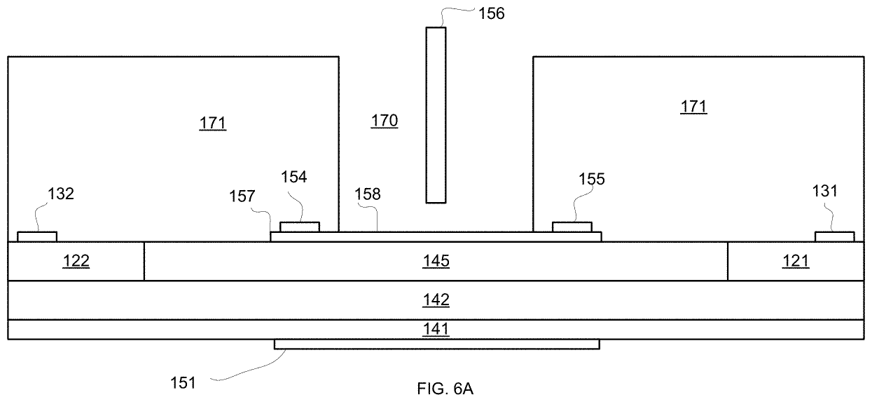

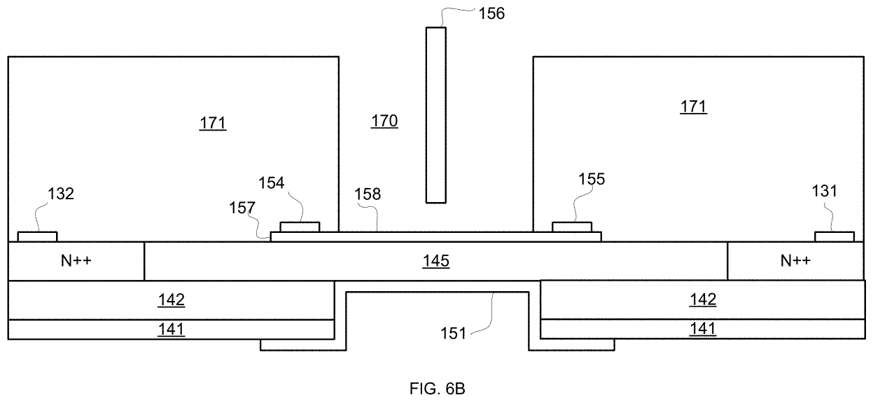

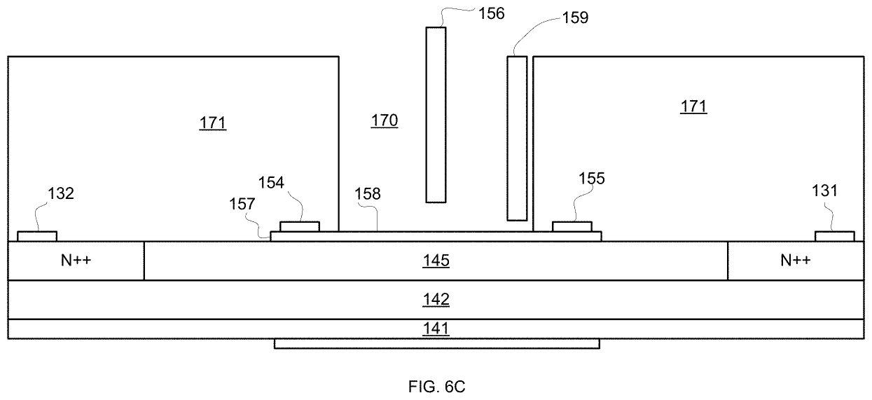

FIGS. 6A, 6B and 6C cross sectional views of examples of the biosensor 100. The cross section is taken at the center of the device along a longitudinal axis.

In FIG. 6A the MNC BioFET includes (from to bottom)—(a) backgate 151 (having a planar shape), (b) substrate (for example a planar silicon substrate) 141, (c) oxide layer 142, (d) drain region 121, active region 145 and source region 122, (e) gate oxide 157 that include sensing aera (also referred to as interface) 158 that interfaces with the liquid, drain contact 131 and source contact 132, (f) two transverse gates 154 and 155, oxide 171 in which the compartment with 170 fluid is formed, and reference electrode 156.

FIG. 6B differs from FIG. 6A by illustrating a biosensor 100 that includes a recess formed at the substrate 141 and the oxide layer 142 exposing the active region 145 to a backgate 151 that may be formed on the bottom of the active region 145 , on the walls of the recess and a part of the substrate 141 over thin oxide (e.g. 40-100A thickness, not shown in FIG. 6B

FIG. 6C differs from FIG. 6A by illustrating a temperature control element 159 (heater and/or cooler) for affecting the temperature of the liquid.

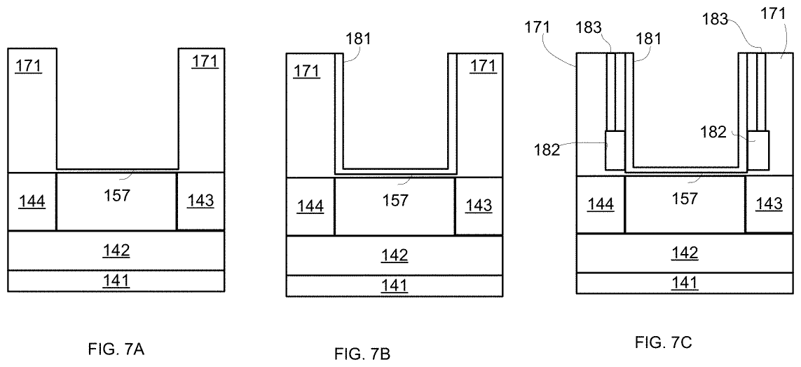

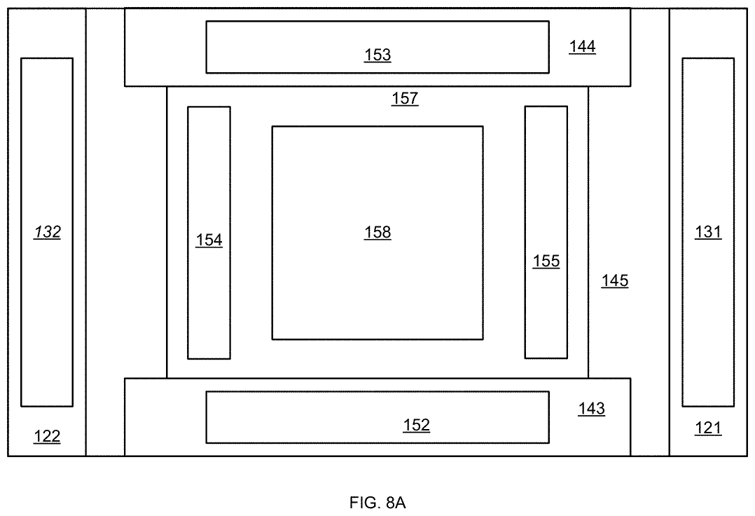

FIGS. 7A, 7B and 7C include cross sectional views of examples of the biosensor 100. The cross section is taken at the center of the device along a transverse axis.

All three figures illustrate various parts of the biosensor 100—(a) substrate 141, (b) oxide layer 142, (d) regions 143 and 144 located below the lateral gates, (e) gate oxide 157, and (f) oxide 171 in which the fluid is filled.

In FIG. 7A the oxide is exposed to the fluid.

In FIG. 7B the oxide 171 is isolated from the fluid by isolating layer 181.

In FIG. 7C the oxide is isolated from the fluid by isolating layer 181 and there are additional electrodes (for example made of polysilicon) 182 that are electrically coupled to contacts 183. The isolating layer 181 is spaced apart from the additional electrodes 182 and the contacts.

The additional electrodes may affect the electrical field of the fluid. Also, need to have the case in which the electrode are in touch with the solution and then we can have ion current flowing between them as well as the reference electrode.

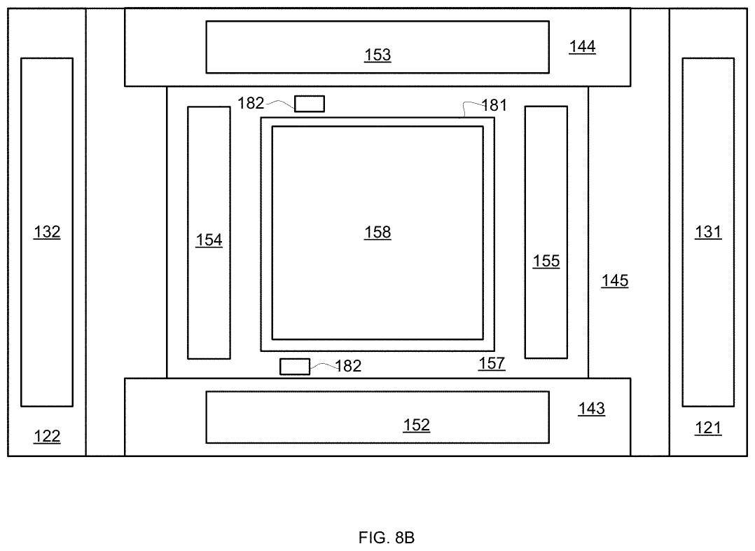

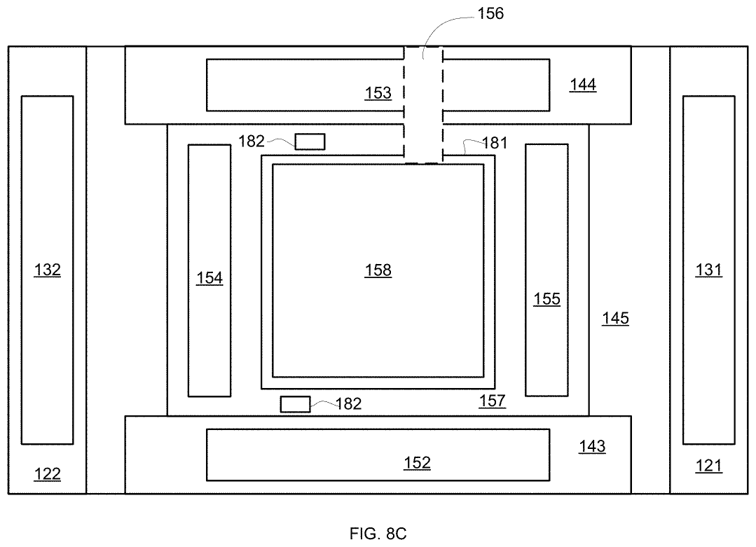

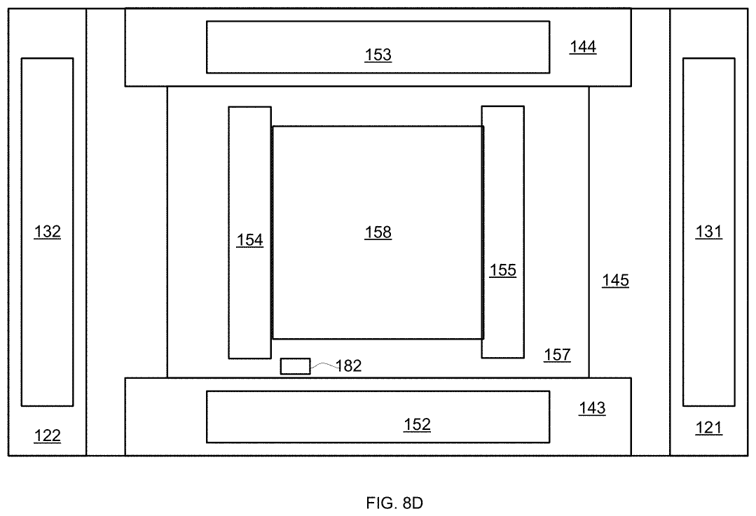

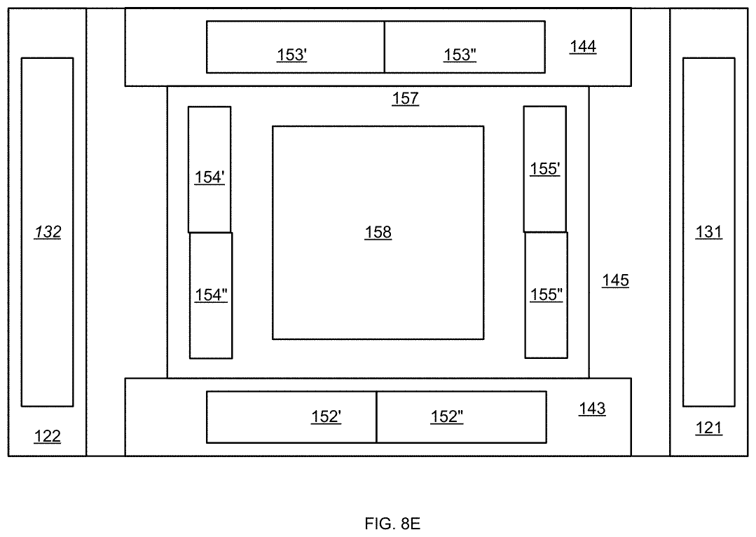

FIGS. 8A, 8B, 8C and 8D are top views of examples of biosensors 100. For simplicity of explanation oxide 171 and other elements were not shown.

FIG. 8A illustrates a biosensor that includes (from left to right) (a) source region 122, (b) source contact 132, (c) active region 145, (d) region 143, (e) region 144, (f) first lateral gate 152, (g) second lateral gate and 153, (h) gate oxide 157, (i) first transverse gate 154, (e) sensing area 158, (g) second transverse gate 155, (h) drain region 121, and (i) drain contact 121.

FIG. 8B illustrates a biosensor that differs from the biosensor of FIG. 8A by (a) having an isolating layer 181 that surround the fluid compartment, and (b) having additional electrodes 182. It should be noted that there may be provided additional electrodes that contact the liquid and are configured to introduce an ion current through the liquid.

FIG. 8C illustrates a biosensor that differs from the biosensor of FIG. 8A by having a reference electrode 156 that contacts the fluid from above.

FIG. 8D illustrates a biosensor that differs from the biosensor of FIG. 8A by having an electrical coupling (for example by contact) between the first and second transverse gates 154 and 155 and the fluid. The first and second transverse gates 154 and 155 may be spaced apart from the fluid but electrically coupled by conductive elements (not shown).

It should be noted that any gate may be replaced by one or more gates (for example one or more independently controlled gates)—for better controlling the biosensor. In FIG. 8E the first lateral gate and the second lateral gate were split to two electrodes each 154′ and 154″ respectively and 155′ and 155″ respectively. The two lateral gates 152 and 153 were split to two electrodes each 152′ and 152″ respectively and 153′ and 153″ respectively.

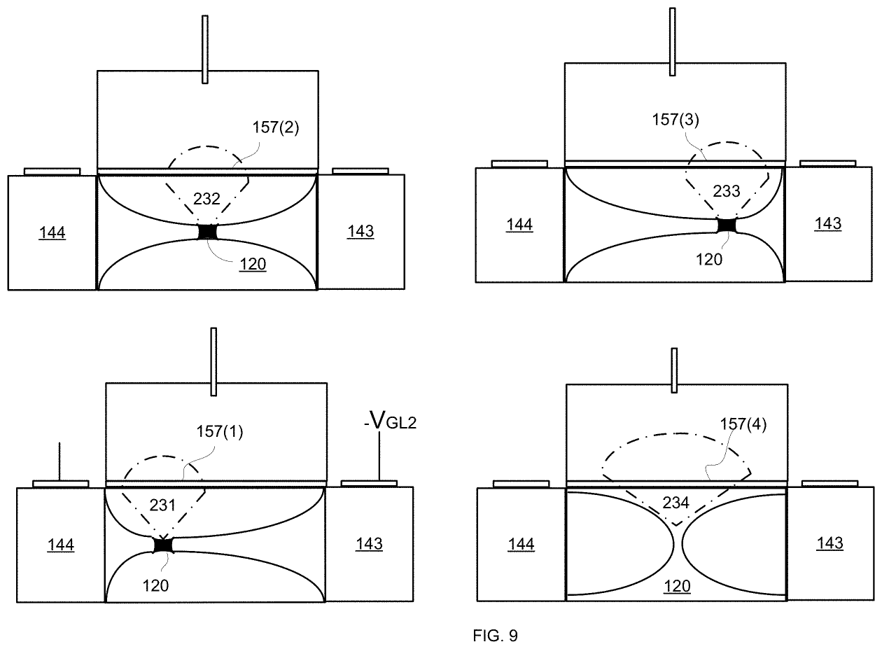

FIG. 9 illustrates four examples of sensing functions 231, 232, 233 and 234 of one or more conductive channels, and most relevant regions 157(1), 157(2), 157(3) and 157(4) of the sensing area obtained at different bias conditions. The sensing function illustrate an example of the sensitivity of each conductive channel per elements of the sensing area. Any other sensing functions may be provided.

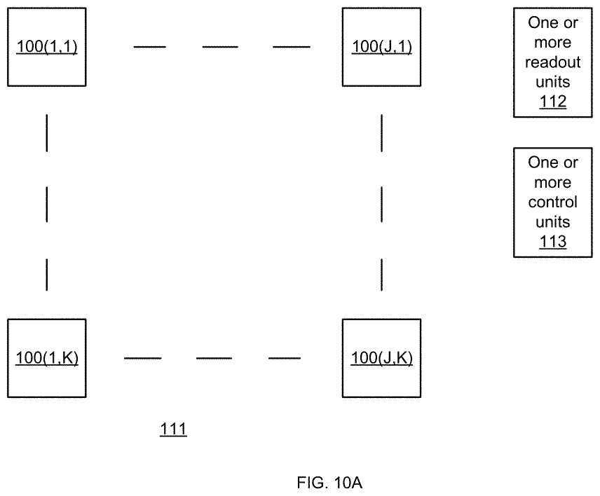

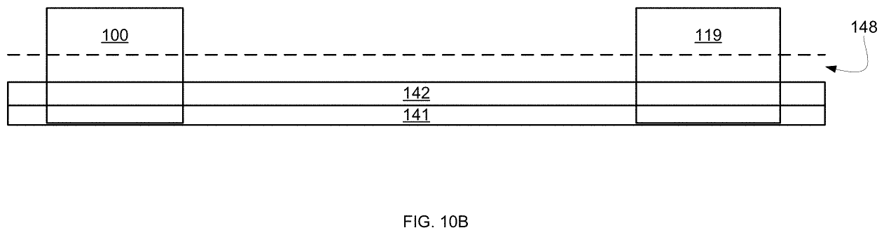

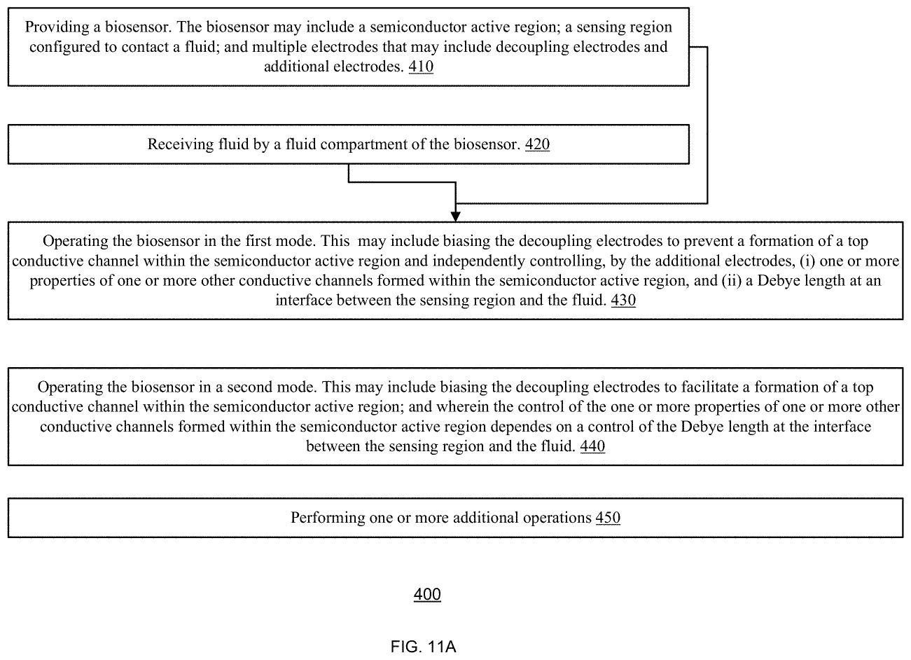

FIG. 10A illustrates an example of an array 111 of J by K biosensors 100(1,1)-100(J,K). The array may be used for sensing multiple samples of the same fluid or different fluids. The biosensors of the arrays may be independently biased or dependently biased.

The array may be a grid, any ordered array, a non-ordered arrangement of biosensors, and the like.

The array may be controlled by one or more control units 113 and may be biased by one or more readout units 112.

FIG. 10B illustrates an example of a biosensor 100 and a CMOS transistor 119. The CMOS transistor and the biosensor 100 may share the substrate 141, oxide layer 142 and may have one or more separated silicon layers 148 on the top of the oxide.

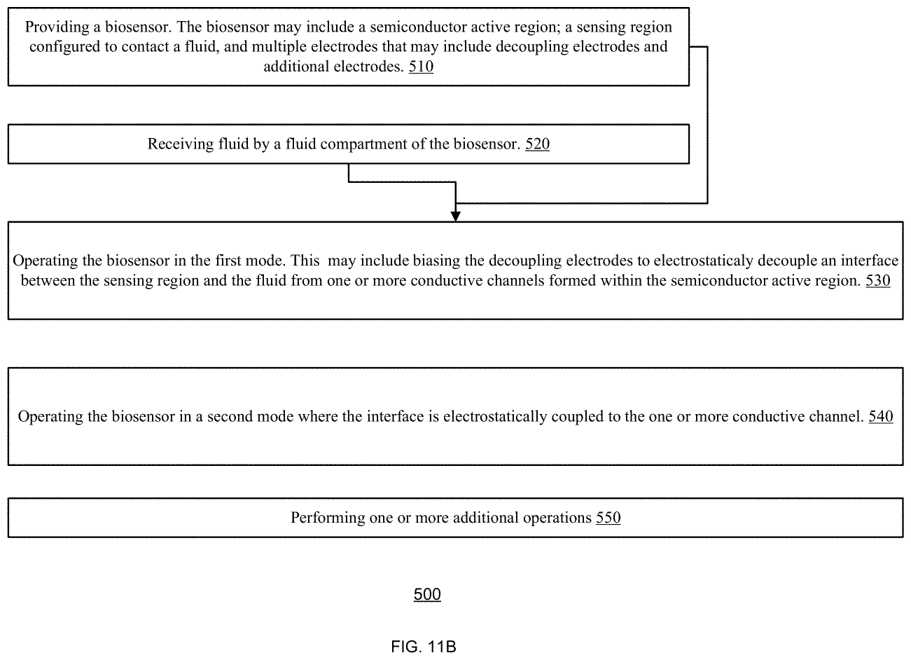

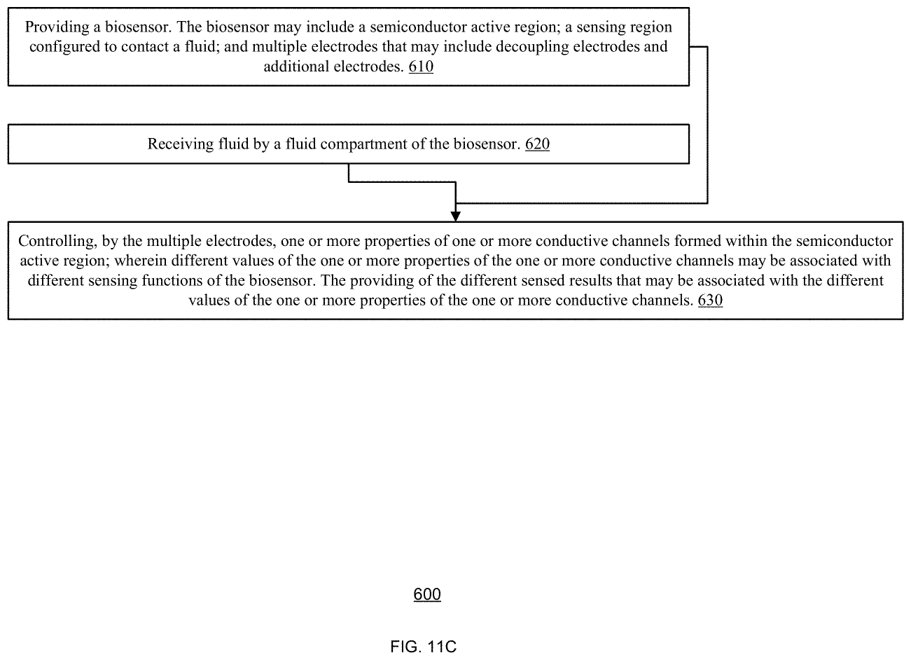

FIG. 11A illustrates an example of a method 400 for operating a biosensor.

Method 400 may start by step 410 of providing a biosensor. The biosensor may include a semiconductor active region; a sensing region configured to contact a fluid; and multiple electrodes that may include decoupling electrodes and additional electrodes.

Step 410 may be followed by step 420 of receiving fluid by a fluid compartment of the biosensor.

Steps 410 and 420 may be followed by step 430 of operating the biosensor in the first mode. It should be noted, that steps 410 and 420 may be followed by step 440.

Step 430 may include biasing the decoupling electrodes to prevent the formation of a top conductive channel within the semiconductor active region and independently controlling by the additional electrodes, (i) one or more properties of one or more other conductive channels formed within the semiconductor active region, and (ii) a Debye length at the interface between the sensing region and the fluid.

The one or more properties may include at least one out of location, shape, volume, area of cross section, any property that may affect the sensing function of the one or more conductive channels, and the like.

There may be any number of conductive channels.

The decoupling electrodes may include one or more decoupling gates. The additional electrodes may include one or more additional gates. The decoupling electrodes may be decoupling gates and the additional electrodes may be additional gates.

Step 430 may include controlling, by the additional gates, the Debye length by depleting a double layer of charged particles at the interface. The decoupling gates may be isolated from the fluid. The decoupling gates may be electrically coupled to the fluid. The additional gates may include a top gate configured to contact the fluid, a bottom gate, and two lateral gates; and wherein the decoupling gates may be two transverse gates.

Method 400 may also include step 440 of operating the biosensor in a second mode.

Step 440 may include biasing the decoupling electrodes to facilitate a formation of a top conductive channel within the semiconductor active region; and wherein the control of the one or more properties of one or more other conductive channels formed within the semiconductor active region depends on a control of the Debye length at the interface between the sensing region and the fluid.

Each one of steps 430 and 440 includes sensing the fluid. This may include sensing at least one interaction between the fluid and the sensing area. The sensing may include sensing only a part of the fluid, sensing any property of the fluid, and the like.

Each one of steps 430 and 440 may include performing one or measurements—in one or more conditions.

The method may also include determining when to operate in each mode.

The method may include operating the biosensor in any other mode.

Steps 430 and 440 refer to the manner in which the sensing is done. It should be noted, that the method may also include step 450 of performing one or more additional operations. Although illustrates as a separate step—at least one additional operation may be executed when in the first mode, when in the second mode, or when in any other mode).

Examples of the one or more additional operations may include sensing a source-drain current, sensing any other signal from the biosensor that is indicative of the fluid, controlling the temperature of the fluid, biasing the fluid, introducing, by two or more gates of the multiple gates, an ion current within the fluid (for example, during an excitation period that may differ than any sensing period, or may overlap with a sensing period), and the like.

The semiconductor active region may be formed above a buried oxide layer of an SOI (silicon on isolator) structure.

The semiconductor active region, the sensing region and the multiple gates may be CMOS fabricated.

FIG. 11B illustrates an example of a method 500.

Method 500 may start by step 510 of providing a biosensor. The biosensor may include a semiconductor active region; a sensing region configured to contact a fluid; and multiple electrodes that may include decoupling electrodes and additional electrodes.

Step 510 may be followed by step 520 of receiving fluid by a fluid compartment of the biosensor.

Steps 510 and 520 may be followed by step 530 of operating the biosensor in the first mode. Step 530 may include biasing the decoupling electrodes to electrostatically decouple the interface between the sensing region and the fluid from one or more conductive channels formed within the semiconductor active region.

Method 500 may also include step 530 of operating the biosensor in a second mode, where the interface is electrostatically coupled to the one or more conductive channel.

Step 530 and/or 540 may include sensing the fluid.

Steps 530 and 540 refer to the manner in which the sensing is done. It should be noted that the method may also include step 550 of performing one or more additional operations. Although illustrates as a separate step—at least one additional operation may be executed when in the first mode, when in the second mode, or when in any other mode).

Examples of the one or more additional operations may include sensing a source-drain current, sensing any other signal from the biosensor that is indicative of the fluid, controlling the temperature of the fluid, biasing the fluid, introducing, by two or more gates of the multiple gates, an ion current within the fluid, and the like.

FIG. 11C illustrates an example of a method 600.

Method 600 may start by step 610 of providing a biosensor. The biosensor may include a semiconductor active region; a sensing region configured to contact a fluid; and multiple electrodes that may include decoupling electrodes and additional electrodes.

Step 610 may be followed by step 620 of receiving fluid by a fluid compartment of the biosensor.

Steps 610 and 620 may be followed by step 630 of sensing the fluid.

Step 630 may include controlling, by the multiple electrodes, one or more properties of one or more conductive channels formed within the semiconductor active region; wherein different values of the one or more properties of the one or more conductive channels may be associated with different sensing functions of the biosensor.

The providing of the different sensed results that may be associated with the different values of the one or more properties of the one or more conductive channels.

For example—sensed information about the fluid may be provided when setting the one or more properties of the one or more channels in various combinations—for example according to at least some of the examples illustrated in FIGS. 2B-2J. The different measurements may be executed when operating in the first mode mentioned above, the second mode mentioned above, or any other mode.

Any reference to any of the terms “comprise”, “comprises”, “comprising” “including”, “may include” and “includes” may be applied to any of the terms “consists”, “consisting”, “consisting essentially of”. For example—any of the rectifying circuits illustrated in any figure may include more components that those illustrated in the figure, only the components illustrated in the figure or substantially only the components illustrated in the figure.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front, ” “back, ” “top, ” “bottom, ” “over, ” “under ” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one ” and “one or more ” in the claims should not be construed to imply that the introduction of another claim element by the indefinite articles “a ” or “an ” limits any particular claim containing such introduced claim element to inventions containing only one such element, even when the same claim includes the introductory phrases “one or more ” or “at least one ” and indefinite articles such as “a ” or “an. ” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A biosensor, comprising:
a semiconductor active region;
a sensing region configured to contact a fluid; and
multiple electrodes that comprise decoupling electrodes and additional electrodes;
wherein the decoupling electrodes are configured, wherein operating in a first mode, to prevent a formation of a top conductive channel within the semiconductor active region; and
wherein the additional electrodes are configured, wherein operating in the first mode, to independently control (i) one or more properties of one or more other conductive channels formed within the semiconductor active region, and (ii) a Debye length at an interface between the sensing region and the fluid.

2. The biosensor according to claim 1, wherein the decoupling electrodes comprise one or more decoupling gates.

3. The biosensor according to claim 1, wherein the additional electrodes comprise one or more additional gates.

4. The biosensor according to claim 1, wherein the decoupling electrodes are decoupling gates, the additional electrodes are additional gates, and the multiple electrodes are multiple gates.

5. The biosensor according to claim 4, wherein the additional gates are configured to control the Debye length by depleting a double layer of charged particles formed at the interface.

6. The biosensor according to claim 4, wherein the decoupling gates are isolated from the fluid.

7. The biosensor according to claim 4, wherein the decoupling gates are electrically coupled to the fluid.

8. The biosensor according to claim 4, wherein the additional gates comprises a top gate configured to contact the fluid, a bottom gate, and two lateral gates; and wherein the decoupling gates are two transverse gates.

9. The biosensor according to claim 4, wherein the semiconductor active region is formed above a buried oxide layer.

10. The biosensor according to claim 4, wherein the one or more properties comprise a location.

11. The biosensor according to claim 4, wherein the one or more properties comprise an area of a cross section.

12. The biosensor according to claim 4, wherein the one or more properties comprise a shape of a cross section.

13. The biosensor according to claim 4, wherein the semiconductor active region, the sensing region and the multiple gates are CMOS fabricated.

14. The biosensor according to claim 4, wherein each conductive channel of the top conductive channel and the one or more other conductive channels, is configured to conduct current between a drain and a source.

15. The biosensor according to claim 4, wherein two or more gates of the multiple gates are configured to introduce an ion current within the fluid.

16. The biosensor according to claim 15, wherein the two or more gates are selected out of the decoupling gates and an additional gate that is in contact with the fluid.

17. The biosensor according to claim 1, wherein the decoupling electrodes are configured, wherein operating in a second mode, to facilitate a formation of a top conductive channel within the semiconductor active region; and wherein a control of the one or more properties of one or more other conductive channels formed within the semiconductor active region depends on a control of the Debye length at the interface between the sensing region and the fluid.

18. A method for operating a biosensor, the method comprising:
providing the biosensor, the biosensor comprising a semiconductor active region; a sensing region configured to contact a fluid and multiple electrodes that comprise decoupling electrodes and additional electrodes;
receiving fluid by a fluid compartment of the biosensor; and
operating the biosensor in a first mode;
wherein the operating of the biosensor in the first mode comprises:
biasing the decoupling electrodes to prevent a formation of a top conductive channel within the semiconductor active region; and
independently controlling, by the additional electrodes, (i) one or more properties of one or more other conductive channels formed within the semiconductor active region, and (ii) a Debye length at an interface between the sensing region and the fluid.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A biosensor, comprising a semiconductor active region; a sensing region configured to contact a fluid; and multiple electrodes that comprise decoupling electrodes and additional electrodes; wherein the decoupling electrodes are configured, wherein operating in a first mode, to electrostatically decouple an interface between the sensing region and the fluid from one or more conductive channels formed within the semiconductor active region.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)
